(19) United States
(12) Patent Application Publication
(10) Pub. No.: US 2009/0245910 A1
(43) Pub. Date: Oct. 1, 2009

(54) Ink ribbon and printer

(75) Inventor: Ryuichi Tagawa, Kanagawa (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 12/379,653

(22) Filed: Feb. 26, 2009

(30) Foreign Application Priority Data
Mar. 28, 2008 (JP) 2008-088758

(51) Int. Cl. B41J 33/00

(52) U.S. Cl. 400/240

(57) ABSTRACT

An ink ribbon includes: a base film having lengthwise shape; a plurality of ink coat regions formed on the base film side by side at intervals of a predetermined distance in the lengthwise direction of the base film; and sensor marks formed on the base film between the ink coat regions to be used to detect the beginning of each of the ink coat regions. The plurality of ink coat regions are constituted by repetition of the regions in a predetermined number of different colors, and the sensor marks are constituted of ink coats of colors selected from the predetermined number of different colors.

### BACKGROUND OF THE INVENTION

1. Field of the Invention

The present invention relates to an ink ribbon and a printer for use therewith. More particularly, the invention relates to an ink ribbon constituted by a base film along which ink coat regions in a predetermined number of colors are arrayed repeatedly, the ink ribbon having sensor marks each formed thereon by ink coats of colors selected from the predetermined number of colors, the sensor marks being positioned in such a manner as to let the beginning of each of the color ink coat regions be detected, so that the ink ribbon eliminates the need for the ordinary coats of black ink (black marks) for detection purposes and contributes to a significant drop ink ribbon costs thanks to the reduced number of processes for manufacturing the ink ribbon.

2. Description of the Related Art

Printers print a color image by overlaying coats of the image in yellow (Y), magenta (M) and cyan (C), in that order, or in yellow (Y), magenta (M), cyan (C) and a laminate (L), in that order. It follows that the printer using an ink ribbon cassette needs to detect the beginning of each of the recurring coats of dyes or pigments in yellow, magenta and cyan (or yellow, magenta, cyan and laminate).

Ordinarily, the starting position of an ink ribbon coat of a given color is detected by having black pigment ink applied to the beginning of each of the color coats and by using an infrared sensor to detect the applied black ink. In printing operation, every image must be printed first in yellow. This requires that the starting position of each coat of yellow be identified using black pigment ink in a manner different from the beginnings of the other coats.

FIG. 33A shows a typical structure of an ordinary ink ribbon 200A on which black pigment ink is applied to the starting position of each of the coats of different colors. The ink ribbon 200A is constituted by a base film 201 along which are arrayed repeatedly an ink coat region 202Y of yellow (Y), an ink coat region 202M of magenta (M), and an ink coat region 202C of cyan (C) in that order, the ink coat regions being at intervals of a predetermined distance.

Between the ink coat regions are black marks 203 formed across the base film 201. Two black marks 203 are furnished at the starting position of each coat of yellow; one black mark 203 is placed at the beginning of each of the coats of the other colors. The printer in operation takes up the ink ribbon 200A while detecting the black marks 203. When detecting two black marks 203 in a row, the printer recognizes the beginning of a coat of yellow; upon detecting a single black mark 203, the printer recognizes the beginning of a coat of some other color.

Depending on the status of the ink ribbon 200A following ink ribbon replacement or immediately after the printer is restarted, the printer may detect the second black mark at the starting position of a yellow coat or may find the second black mark 203 moved past its mark detector. In such cases, the attempt to detect the beginning of a yellow coat can have the ink ribbon taken up unused for one image, which is a wasteful operation.

Illustratively, Japanese Patent Laid-Open No. 2001-80182 discloses an ink ribbon 200B shown in FIG. 33B. On the ink ribbon 200B constituted by a base film 201, each black mark 203 formed between two ink coat regions is split into “n” (e.g., three) parts across the film. The pattern constituted by the parts of the black ink mark 203 at the starting position of each yellow coat is different from the pattern at the beginnings of the other color coats. On this ink ribbon 200B, when the black mark at the beginning of a yellow coat is detected, the pattern of the black mark is interpreted as the starting position of the yellow coat.

### SUMMARY OF THE INVENTION

According to an embodiment of the present invention, the ordinary manufacturing of the ink ribbon with black marks formed between the ink coat regions of different colors requires applying black ink onto the ribbon to form the black marks thereon, in addition to the processes of applying coats of yellow, magenta and cyan (or of yellow, magenta, cyan and laminate) to the ribbon. The additional processes make the ink ribbon that much more expensive.

The present invention has been made in view of the above circumstances and provides an inexpensive ink ribbon through a reduced number of manufacturing processes.

According to an embodiment of the present invention, there is provided an ink ribbon including: a base film having lengthwise shape; a plurality of ink coat regions formed on the base film side by side at intervals of a predetermined distance in the lengthwise direction of the base film; and sensor marks formed on the base film between the ink coat regions to be used to detect the beginning of each of the ink coat regions. The plurality of ink coat regions are constituted by repetition of the regions in a predetermined number of different colors. The sensor marks are constituted of ink coats of colors selected from the predetermined number of different colors.

On the inventive ink ribbon constituted by the base film having lengthwise shape, a plurality of ink coat regions are formed at intervals of a predetermined distance. The multiple ink coat regions are constituted by repetition of the regions in a predetermined number of different colors. Preferably, the predetermined number of colors may be yellow, magenta, and cyan; or yellow, magenta, cyan, and laminate (transparent).

Sensor marks are formed on the base film between the ink coat regions to be used to detect the beginning of each of the ink coat regions. The sensor marks are constituted of ink coats of colors selected from the predetermined number of different colors. This structure eliminates the need for applying black ink onto the ink ribbon for detection purposes. The reduced number of processes for manufacturing the ink ribbon contributes to lowering ink ribbon costs.

Preferably, the sensor marks positioned at the beginning of the ink ribbon regions in the predetermined number of different colors may be constituted of a first color ink coat and a second color ink coat. This structure makes it possible to detect the beginning of a desired number of color ink coat regions (e.g., beginning of the ink coat regions making up a single image).

Preferably, the first color ink coat and the second color ink coat may be arrayed in the lengthwise direction of the base film. In this case, it might happen that depending on the colors of the ink coats making up the sensor mark, the array of a given ink coat region and of the ensuing sensor mark is the same as the array of the first and the second color ink coats constituting the sensor mark at the beginning of the ink coat regions in the predetermined number of colors. This could lead to erroneous detection of the starting position of the ink coat regions in the predetermined number of colors.

The bottleneck above may be circumvented as follows: a first distance is the distance in the lengthwise direction of the base film between the first color ink coat and the second color ink coat. A second distance is the distance in the lengthwise direction of the base film between a region of the first color ink coat formed on the base film on the one hand and the sensor mark constituted of the second color ink coat adjacent to that region of the first color ink coat on the other hand. In this case, the first and the second distances are arranged in such a manner that the second distance is longer than the first distance. This structure prevents the array of a given ink coat region and of the ensuing sensor mark from getting erroneously detected as the beginning of the ink coat regions in a predetermined number of colors.

Alternatively, the first color ink coat and the second color ink coat may be arrayed in the crosswise direction of the base film. With this structure, there is no possibility of the erroneous detection taking place as in the case of the first and the second color ink coats being arrayed in the lengthwise direction of the base film.

According to another embodiment of the present invention, there is provided a printer including an ink ribbon mounting section configured to be a section on which to mount an ink ribbon. The ink ribbon includes: a base film having lengthwise shape; a plurality of ink coat regions formed on the base film side by side at intervals of a predetermined distance in the lengthwise direction of the base film; and sensor marks formed on the base film between the ink coat regions to be used to detect the beginning of each of the ink coat regions. The plurality of ink coat regions are constituted by repetition of the regions in a predetermined number of different colors, and the sensor marks are constituted of ink coats of colors selected from the predetermined number of different colors. The printer further includes: an ink ribbon feed section configured to feed the ink ribbon mounted on the ink ribbon mounting section in the lengthwise direction of the base film; a sensor mark detection section configured to detect the sensor marks on the ink ribbon fed by the ink ribbon feed section; a print head configured to be supplied with print data; and a print control section configured to control the ink ribbon feed section and the print head in operation based on detection outputs of the sensor mark detection section.

According to embodiments of the present invention, as outlined above, an ink ribbon is formed in the lengthwise direction of a base film wherein a plurality of ink coat regions are formed repeatedly on the base film in a predetermined number of colors and wherein sensor marks are constituted of ink coats of colors selected from the predetermined number of colors, the sensor marks being used to detect the beginning of the ink coat regions in the predetermined number of colors. The inventive structure eliminates the need for the application of black ink (black marks) onto the base film for detection purposes. The reduced number of processes for manufacturing the ink ribbon contributes to lowering ink ribbon costs.

### BRIEF DESCRIPTION OF THE DRAWINGS

FIG. 1 is a perspective view showing a typical structure of a printer practiced as one embodiment of the present invention;

FIGS. 2A and 2B are schematic views explanatory of how energizing time is controlled for print density expression;

FIG. 3 is a flowchart of steps explanatory of how the printer works;

FIG. 4 is a flowchart of steps explanatory of how the beginning of a yellow ink coat is detected;

FIGS. 5A and 5B are schematic views explanatory of an ink ribbon with coats of three colors and an ink ribbon with coats of four colors;

FIGS. GA, 6B, 6C, 6D, GE, and 6F are schematic views explanatory of typical orders in which color ink coats are applied to a three-color-coated ink ribbon;

FIGS. 7A, 7B, 7C, 7D, 7E, and 7F are schematic views explanatory of typical orders in which color ink coats are applied to a four-color-coated ink ribbon;

FIGS. 8A and 8B are schematic views showing how a first color sensor and a second color sensor are arrayed so as to constitute a mark sensor;

FIGS. 9A and 9B are schematic views showing typical structures of an ink ribbon made of a base film on which ink coat regions of yellow (Y), magenta (M), and cyan (C) are arrayed repeatedly, in that order (where sensors are positioned for a C/Y lengthwise array and a Y/C crosswise array);

FIGS. 10A, 10B, and 10C are graphic representations showing typical transmittance characteristics of color ink coats on the ink ribbon;

FIG. 11 is a graphic representation showing a typical light emission spectrum of a white LED (light-emitting device) serving as a light-emitting device;

FIG. 12 is a graphic representation showing typical light reception sensitivity characteristics of different color sensors serving as light-receiving devices;

FIGS. 13A and 13B are a schematic and a tabular view showing a setup in which a white LED and a color LED are positioned opposite to each other across the ink ribbon, and typical output levels of red, green and blue sensors with regard to the ink coats of yellow (Y), magenta (M), cyan (C), and laminate (L) on the ink ribbon in that setup;

FIGS. 14A and 14B are schematic views showing typical yellow sensor structures for detecting the yellow ink coat on the ink ribbon;

FIGS. 15A and 15B are schematic views showing typical magenta sensor structures for detecting the magenta ink coat on the ink ribbon;

FIGS. 16A and 16B are schematic views showing typical yellow sensor structures for detecting the cyan ink coat on the ink ribbon;

FIGS. 17A and 17B are schematic views showing typical structures of an ink ribbon made of a base film on which ink coat regions of yellow (Y), magenta (M), and cyan (C) are arrayed repeatedly, in that order (where sensors are positioned for a Y/C lengthwise array);

FIGS. 18A and 18B are schematic views showing typical structures of an ink ribbon made of a base film on which ink coat regions of yellow (Y), magenta (M), and cyan (C) are arrayed repeatedly, in that order (where sensors are positioned for a C/M lengthwise array and an M/C crosswise array);

FIGS. 19A and 19B are schematic views showing typical structures of an ink ribbon made of a base film on which ink coat regions of yellow (Y), magenta (M), and cyan (C) are arrayed repeatedly, in that order (where sensors are positioned for an M/C lengthwise array);

FIGS. 20A, 20B, and 20C are schematic views showing typical structures of an ink ribbon made of a base film on which ink coat regions of yellow (Y), magenta (M), and cyan (C) are arrayed repeatedly, in that order (where sensors are positioned for a Y/M lengthwise array and an M/Y crosswise array);

FIGS. 21A and 21B are schematic views showing typical structures of an ink ribbon made of a base film on which ink coat regions of yellow (Y), magenta (M), and cyan (C) are arrayed repeatedly, in that order (where sensors are positioned for an M/Y lengthwise array);

FIGS. 22A, 22B, and 22C are schematic views showing typical structures of an ink ribbon made of a base film on which ink coat regions of yellow (Y), magenta (M), cyan (C), and laminate (L) are arrayed repeatedly, in that order (where sensors are positioned for a C/Y lengthwise array and a Y/C crosswise array);

FIGS. 23A and 23B are schematic views showing typical structures of an ink ribbon made of a base film on which ink coat regions of yellow (Y), magenta (M), cyan (C), and laminate (L) are arrayed repeatedly, in that order (where sensors are positioned for a Y/C lengthwise array);

FIGS. 24A, 24B, and 24C are schematic views showing typical structures of an ink ribbon made of a base film on which ink coat regions of yellow (Y), magenta (M), cyan (C), and laminate (L) are arrayed repeatedly, in that order (where sensors are positioned for a C/M lengthwise array and an M/C crosswise array);

FIGS. 25A and 25B are schematic views showing typical structures of an ink ribbon made of a base film on which ink coat regions of yellow (Y), magenta (M), cyan (C), and laminate (L) are arrayed repeatedly, in that order (where sensors are positioned for an M/C lengthwise array);

FIGS. 26A, 26B, and 26C are schematic views showing typical structures of an ink ribbon made of a base film on which ink coat regions of yellow (Y), magenta (M), cyan (C), and laminate (L) are arrayed repeatedly, in that order (where sensors are positioned for a Y/M lengthwise array and a Y/M crosswise array);

FIGS. 27A and 27B are schematic views showing typical structures of an ink ribbon made of a base film on which ink coat regions of yellow (Y), magenta (M), cyan (C), and laminate (L) are arrayed repeatedly, in that order (where sensors are positioned for an M/Y lengthwise array);

FIG. 28 is a schematic view showing a typical structure of a mark sensor;

FIGS. 29A and 29B are schematic views showing typical structures of ink ribbons and mark sensors for detecting the beginning of a first color;

FIG. 30 is a flowchart of steps explanatory of how the beginning of a first color (e.g., ink coat region of yellow (Y)) is detected based on the detection output of the mark sensor;

FIG. 31 is a flowchart of steps explanatory of how the beginning of a first color (e.g., ink coat region of yellow (Y)) is detected traditionally based on the detection output of the mark sensor;

FIGS. 32A and 32B are schematic views explanatory of how the mark sensor of the printer designed to use the inventive ink ribbon can also detect the beginning of a given color on an ordinary ink ribbon; and

FIGS. 33A and 33B are schematic views showing typical structures of ordinary ink ribbons.

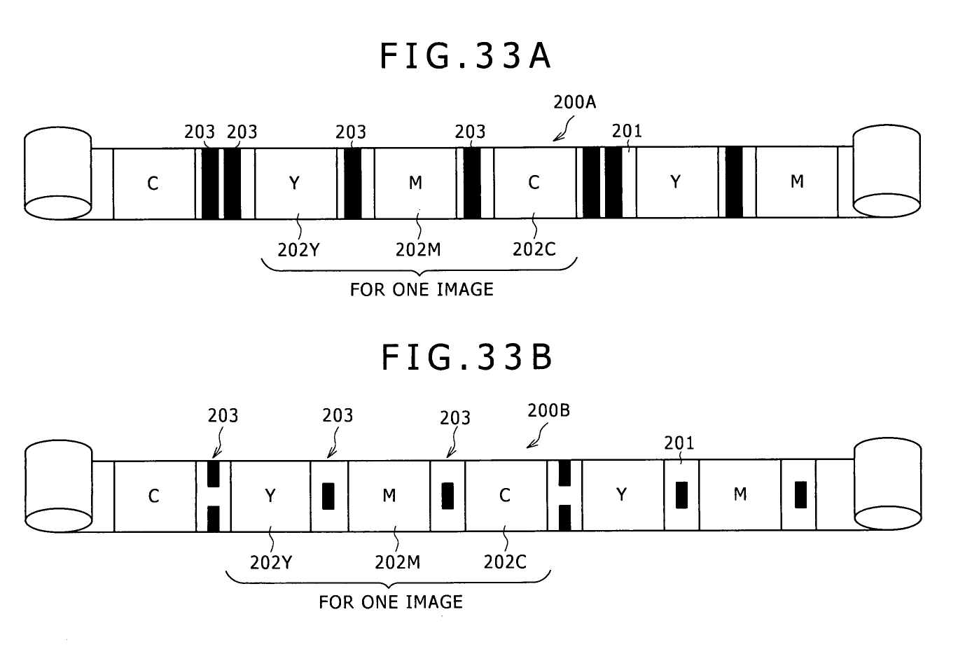

### DETAILED DESCRIPTION OF THE PREFERRED EMBODIMENTS

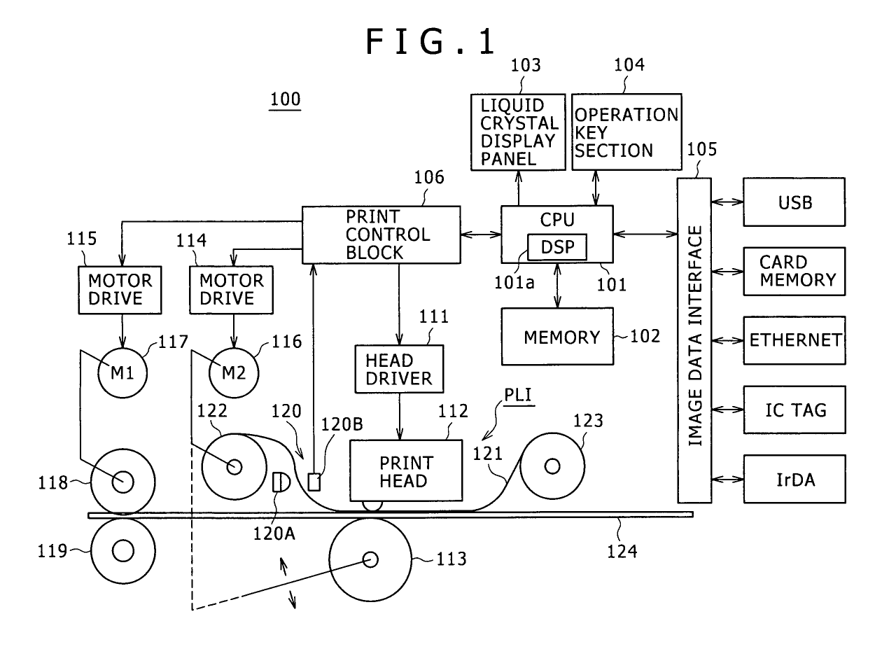

The preferred embodiments of the present invention will now be described in reference to the accompanying drawings. FIG. 1 schematically shows a typical structure of a printer 100 practiced as one embodiment of the present invention.

The printer 100 includes a CPU 101, a memory 102, a liquid crystal display panel 103, an operation key section 104, an image data interface 105, a print control block 106, a head driver 111, a print head 112, a platen 113, motor drivers 114 and 115, motors 116 and 117, a capstan 118, a pinch roller 119, a mark sensor 120, an ink ribbon 121, and a print sheet 124.

The CPU 101 controls the workings of the components making up the printer 100. The memory 102 is connected to the CPU 101 and typically constituted by a ROM (Read-Only Memory) and a RAM (Random Access Memory). The ROM accommodates primarily the programs run by the CPU 101. The RAM is used mainly as a work area of the CPU 101. The RAM is also used to store the image data input through the image data interface 105, to be discussed later. The CPU 101 performs control operations by retrieving relevant programs from the ROM and expanding them for execution in the RAM.

The liquid crystal display panel 103 and operation key section 104 connected to the CPU 101 constitute a user interface. The user may perform diverse input operations by operating the operation key section 104. The liquid crystal display panel 103 mainly displays images to be printed, details of the operations performed by the user, and operation status of the printer 100.

The image data interface 105 connected to the CPU 101 is an interface through which to input the images to be printed. The image data interface 105 makes it possible to input image data (i.e., print data) from a USB, a card memory, an Ethernet (registered trademark) setup, an IC tag, IrDA, etc. The input image data is sent to and held in the memory 102 by way of the CPU 101.

The CPU 101 is furnished with a DSP 101a. If the image data input through the CPU 101 and image data interface 105 turns out to be image data compressed in JPEG (Joint Photographic Experts Group) format or the like, then the DSP 101a expands the input data into uncompressed image data.

The CPU 101 edits the input image data to a suitable print size beforehand. For example, if the printer 100 has a resolution of 300 DPI by 300 DPI for printing onto a 4-inch by 6-inch sheet (i.e., postcard size), the CPU 101 compresses or expands the input image data to a 1,200-dot by 1,800-dot size.

The CPU 101 decomposes the color components of the input image data into yellow component data, magenta component data, and cyan component data. When an image is to be printed, a yellow image is first printed using the yellow component data, followed by a magenta image using the magenta component data and a cyan image using the cyan component data.

Because yellow, magenta and cyan make up the subtractive primaries, the images in the three colors are superimposed one upon another when printed to reconstitute an original color image on a white sheet (i.e., print sheet). There are a number of ways in which to transfer the three fundamental colors to the print sheet. The printer 100 according to an embodiment of the present invention is a thermal transfer printer that thermally transfers to a print sheet the ink of an ink ribbon coated with the three primary colors.

What follows is a further explanation of the thermal transfer printer. The thermal transfer printer works typically as follows: heating devices on the thermal head are first heated by Joule heat. The heat detaches bits of ink from the base film of the ink-coated ink ribbon. The detached ink is absorbed by a receptive layer of the print sheet, whereby thermal ink transfer from the ink ribbon to the print sheet is accomplished.

The amount of ink transferred to the print sheet is increased or decreased in proportion to the heating value of the thermal head. A higher heating value of the thermal head raises the amount of ink to be transferred to the print sheet, so that the transferred color becomes denser. Conversely, a lower heating value of the thermal head reduces the amount of ink to be transferred, with the transferred color becoming thinner. That means the expression in variable print density is made possible by suitably controlling the Joule heat of the heating devices on the thermal head of the thermal transfer printer.

A two-dimensional expression of an image is achieved illustratively as follows: a total of, say, 1,200 heating devices are arrayed to form a column on the thermal head. The heating devices are heated all at once to form a column of the image. The ink ribbon and print sheet are fed, one column at a time, in the direction perpendicular to the array of the heating devices on the thermal head. Every time the ink ribbon and print sheet are fed by one column, one column of the image is printed. After the ink ribbon and print sheet are fed by 1,800 columns, the image is printed in the postcard size of 1,200 dots by 1,800 dots.

As described above, the thermal transfer printer permits printing in variable density by suitably controlling the Joule heat of the heating devices on the thermal head. The Joule heat is defined by the following expression (1):

Joule heat [J]=power [watts]×energizing time [seconds] (1)

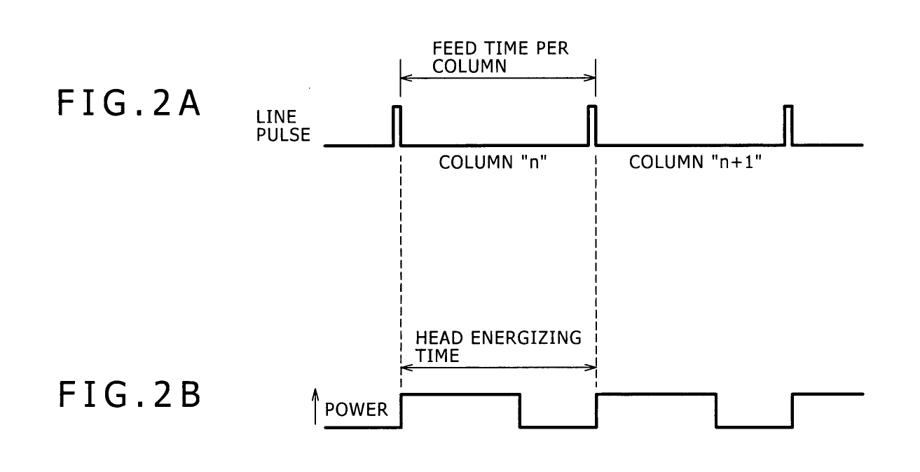

As can be understood from the expression (1) above, either power or energizing time may be controlled to obtain desired levels of density in expression. In terms of response, it is preferable to control the energizing time for variable print density. As shown in FIGS. 2A and 2B, the energizing time for each of the thermal heads may be controlled within a feed time per column in keeping with varying degrees of density in expression. FIG. 2A shows a line pulse representing the feed time per column. FIG. 2B indicates a head energizing time per column. There have been proposed a number of modes in which to control the energizing time, such as power-saving mode, high image quality mode, and efficient control mode.

Returning to FIG. 1, the print control block 106 under control of the CPU 101 controls the operation of an ink ribbon feed section configured to feed the ink ribbon 103, the operation of the print head 112, etc. The head drive 111 under control of the print control block 106 drives the print head 112. The print head 112 is a line thermal head on which heating devices are aligned in a straight line.

The platen 113 is positioned opposite to the heating devices arrayed on the print head 112. In operation, the platen 113 presses the ink ribbon 121 against the print sheet 124 so that when heated by the heating devices of the print head 112, the ink of the ink ribbon will be transferred unfailingly to the print sheet 124.

The ink ribbon 121 is mounted on an ink ribbon mounting section PLI of the printer 100. The ink ribbon 121 is paid out from a feed bobbin 123 and taken up by a take-up bobbin 122. The motor drive 114 under control of the print control block 106 controls the motor 116. When rotating in the forward direction, the motor 116 turns the take-up bobbin 122 in a manner taking up the ink ribbon 121. When rotating in the reverse direction, the motor 116 opens and closes the platen 113. The motor drive 114, motor 116, and take-up bobbin 122 make up the ink ribbon feed section configured to feed the ink ribbon.

The motor drive 115 under control of the print control block 106 drives the motor 117. The motor 117 in turn controls the capstan 118. The capstan 118, together with the pinch roller 119, constitutes a print sheet feed section configured to feed the print sheet 124.

As will be discussed later, the ink ribbon 121 is made of a base film on which ink coat regions of yellow (Y), magenta (M), and cyan (C) are arrayed repeatedly in that order, or on which ink coat regions of yellow (Y), magenta (M), cyan (C), and laminate (L) are arrayed repeatedly in that order. Between the ink coat regions of the different colors is a sensor mark positioned to permit detection of the beginning of each of the ink coat regions. The mark sensor 120 detects these sensor marks on the ink ribbon 121. The detection output of the mark sensor 120 is sent to the print control block 106 as control information.

The mark sensor 120 is constituted by a light-emitting device 120A and a light-receiving device 120B positioned opposite to each other across the ink ribbon 121. The ink ribbon 121 and mark sensor 120 will be discussed later in more detail.

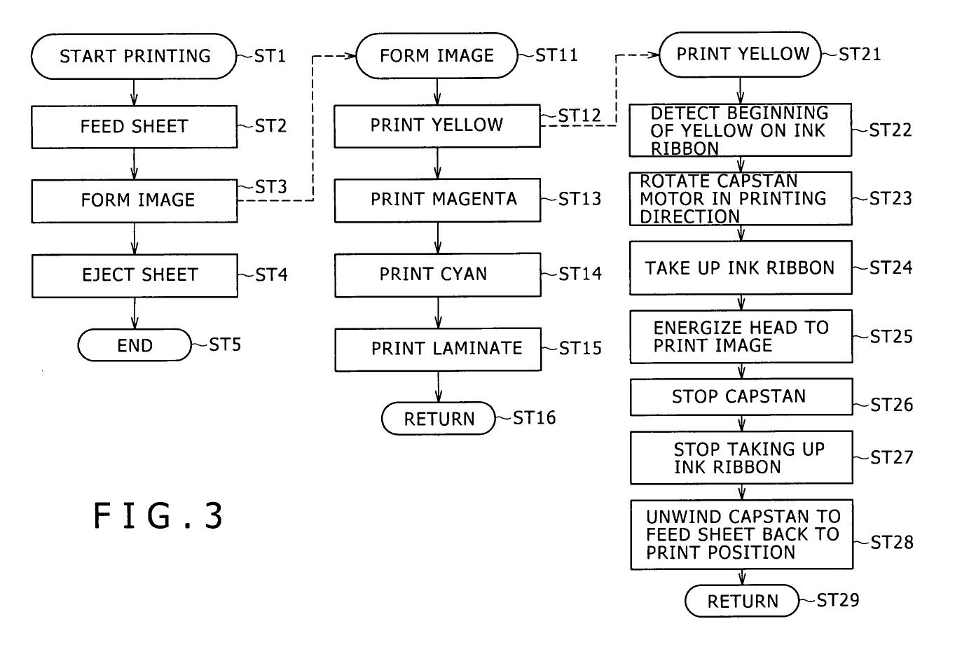

How the printer 100 shown in FIG. 1 typically works will now be described by referring to the flowchart of FIG. 3. In this example, an image is printed in yellow (Y), magenta (M) and cyan (C), in that order, before laminate is printed on the resulting image.

The user first issues a print instruction by operating the operation key section 104. The instruction causes the print control block 106 to go to step ST1 and starts a printing operation. In step ST2, the print control block 106 feeds the print sheet 124. In step ST3, the print control block 106 forms the image. Thereafter the print control block 106 reaches step ST4 and ejects the print sheet 124. In step ST5, the print control block 106 terminates the printing operation.

The image forming operation of step ST3 includes the following detailed steps: in step S11, the image forming process is started. In step ST12, step ST13, and step ST14, the print control block 106 causes a yellow image, a magenta image, and a cyan image to be printed, respectively. In step ST15, the print control block 106 causes laminate to be printed. In step ST16, the image forming process is terminated and control is returned.

The yellow image printing operation of step ST12 includes the following detailed steps: in step ST21, the print control block 16 starts the yellow image printing operation. In step ST22, the print control block 106 detects the beginning of a yellow ink coat region on the ink ribbon 121.

In step ST23, the print control block 106 drives the motor 117 to rotate the capstan 118 in the printing direction. In step ST24, the print control block 106 drives the motor 116 to rotate the take-up bobbin 122 in the take-up direction. In step ST25, the print control block 106 causes the head driver 111 to drive the print head 112 based on yellow image data in order to print the yellow image on the print sheet 124.

When the yellow image printing operation is finished, the print control block 106 goes to step ST26 and stops the capstan 118 rotating. In step ST27, the print control block 106 stops the take-up bobbin 122 rotating. In step ST28, the print control block 106 rotates the capstan 118 in the direction opposite to that of printing so as to return the print sheet 126 to the print position. In step ST29, the print control block 106 terminates the yellow image printing operation.

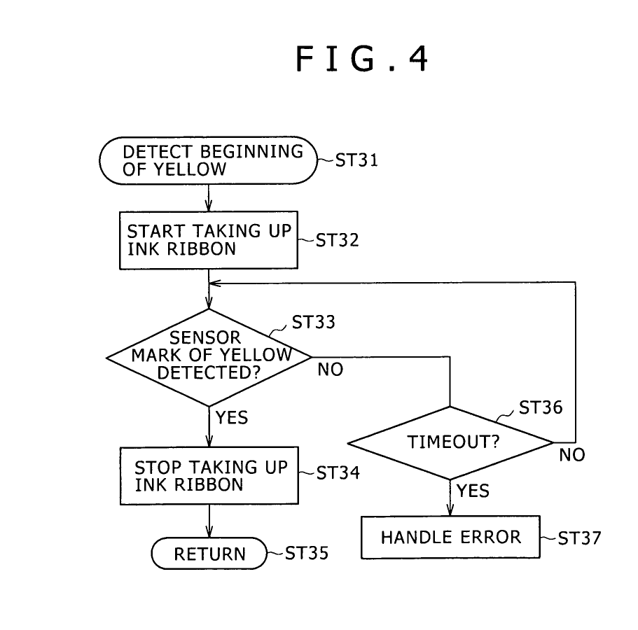

The flowchart of FIG. 4 shows detailed steps constituting the operation of detecting the beginning of a yellow ink coat region in step ST22. In step ST31, the print control block 106 starts the detecting operation. In step ST32, the print control block 106 starts taking up the ink ribbon 121. In step ST33, the print control block 106 checks to determine whether the mark sensor 120 has detected a sensor mark at the starting position of a yellow ink coat region (i.e., yellow sensor mark).

While the yellow sensor mark is not being detected, the print control block 106 goes to step ST36 and checks to determine whether a timeout has occurred. A timeout is found to have occurred upon elapse of the time period within which the yellow sensor mark should have been detected. While a timeout has yet to occur, the print control block 106 returns to step ST33. In the event of a timeout, an exhausted ink ribbon, a defective ink ribbon, or a failed motor is suspected. In this case, the print control block 106 reaches step ST37 and performs error handling.

If a yellow sensor mark is found to be detected in step ST33, the print control block 106 goes to step ST34. In step ST34, the print control block 106 stops taking up the ink ribbon 121. In step ST35, control is returned.

The steps above for printing the yellow image also hold for the operations of printing the magenta image, cyan image, and laminate shown in FIG. 3. Whereas the printing operation indicated in FIG. 3 involves printing four colors (yellow, magenta, cyan, and laminate), a three-color printing operation excludes the printing of laminate.

The ink ribbon 121 and mark sensor 120 will now be described.

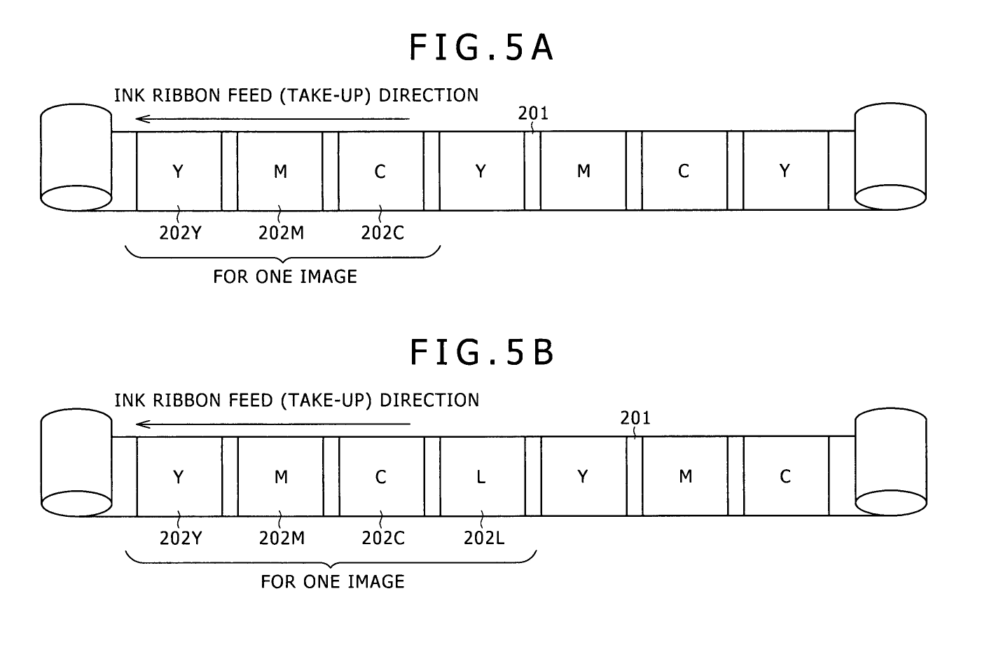

There may be two types of ink ribbons: a three-color-coated ink ribbon shown in FIG. 5A, and a four-color-coated ink ribbon indicated in FIG. 5B. The three-color-coated ink ribbon is made of a base film 201 which is formed lengthwise and on which an ink coat region 202Y of yellow (Y), an ink coat region 202M of magenta (M), and an ink coat region 202C of cyan (C) are arrayed in the lengthwise direction at intervals of a predetermined distance. Each set of a yellow (Y) ink coat region 202Y, a magenta (M) ink coat region 202M, and a cyan (C) ink coat region 202C makes up the ink coats for forming a single image.

The four-color-coated ink ribbon is made of a base film 201 which is formed lengthwise and on which an ink coat region 202Y of yellow (Y), an ink coat region 202M of magenta (M), an ink coat region 202C of cyan (C), and an ink coat region 202L of laminate (L) are arrayed in the lengthwise direction at intervals of a predetermined distance. Each set of a yellow (Y) ink coat region 202Y, a magenta (M) ink coat region 202M, a cyan (C) ink coat region 202C, and a laminate (L) ink coat region 202L makes up the ink coats for forming a single image.

There are a number of proposed orders in which to apply coats of different colors to the base film depending on desired print characteristics. FIGS. 6A through 6F show orders in which to apply the coats of three colors onto the three-color-coated ink ribbon. More specifically, FIG. 6A shows ink coat regions arrayed in yellow (Y), magenta (M) and cyan (C), in that order. FIG. 6B indicates ink coat regions arrayed in yellow (Y), cyan (C) and magenta (M), in that order. FIG. 6C depicts ink coat regions arrayed in cyan (C), yellow (Y) and magenta (M), in that order.

FIG. 6D illustrates ink coat regions arrayed in cyan (C), magenta (M) and yellow (Y), in that order. FIG. 6E sketches ink coat regions arrayed in magenta (M), yellow (Y) and cyan (C), in that order. FIG. 6F presents ink coat regions arrayed in magenta (M), cyan (C) and yellow (Y), in that order.

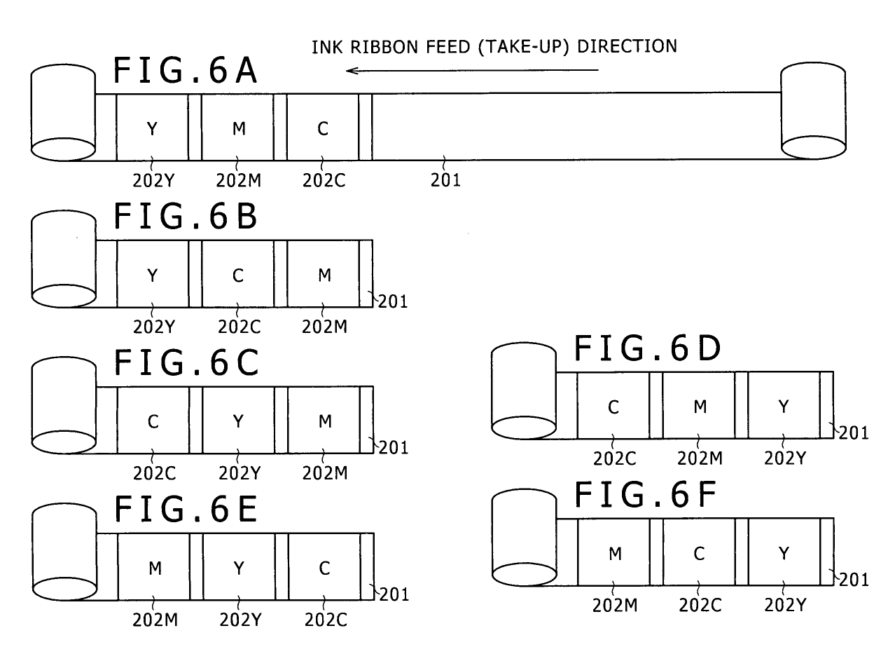

FIGS. 7A through 7F show orders in which to apply the coats of four colors onto the four-color-coated ink ribbon. More specifically, FIG. 7A shows ink coat regions arrayed in yellow (Y), magenta (M), cyan (C) and laminate (L), in that order. FIG. 7B indicates ink coat regions arrayed in yellow (Y), cyan (C), magenta (M) and laminate (L), in that order. FIG. 7C depicts ink coat regions arrayed in cyan (C), yellow (Y), magenta (M) and laminate (L), in that order.

FIG. 7D illustrates ink coat regions arrayed in cyan (C), magenta (M), yellow (Y) and laminate (L), in that order. FIG. 7E sketches ink coat regions arrayed in magenta (M), yellow (Y), cyan (C) and laminate (L), in that order. FIG. 7F presents ink coat regions arrayed in magenta (M), cyan (C), yellow (Y) and laminate (L), in that order.

In the above-described ink ribbon structures, the ink ribbon 121 is constituted on the base film 201 by repeated arrays of yellow (Y), magenta (M) and cyan (C) ink coat region; or by repeated arrays of yellow (Y), magenta (M), cyan (C) and laminate (L) ink coat regions. Between the ink coat regions of different colors is the sensor mark for permitting detection of the beginning of each of the regions.

The sensor mark is made up of ink coats of colors selected from yellow (Y), magenta (M) and cyan (C). A single image is formed either from each set of yellow (Y), magenta (M) and cyan (C) ink coat regions 202Y, 202M and 202C; or from each set of yellow (Y), magenta (M), cyan (C) and laminate (L) ink coat regions 202Y, 202M, 202C and 202L, on the ink ribbon 121. The sensor mark at the beginning of each set of ink coat regions is constituted of a first color ink coat and a second color ink coat.

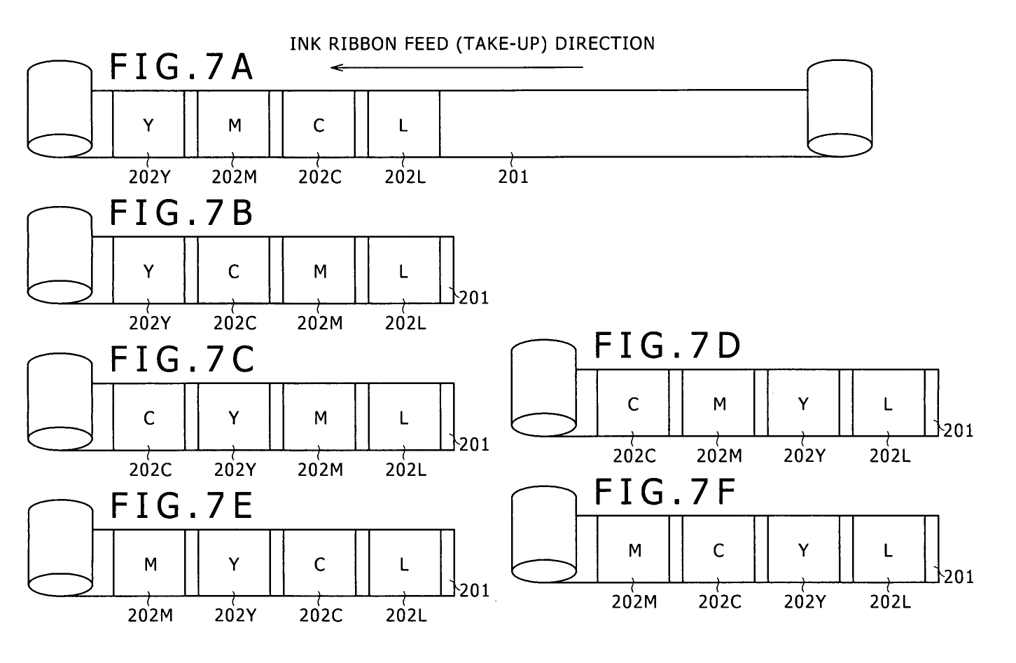

The first and the second color ink coats may be arrayed in the lengthwise direction of the base film 201 (i.e., lengthwise array). In this case, as shown in FIG. 8A, the mark sensor 120 is composed of a first color sensor and a second color sensor arrayed in the lengthwise direction of the base film 201 in a manner addressing the first and the second color ink coats formed along the base film 201.

On the other hand, the first and the second color ink coats may be arrayed in the crosswise direction of the base film 201 (i.e., crosswise array). In this case, as indicated in FIG. 8B, the mark sensor 120 is constituted by a first color sensor and a second color sensor arrayed in the crosswise direction of the base film 201 in a manner addressing the first and the second color ink coats formed across the base film 201.

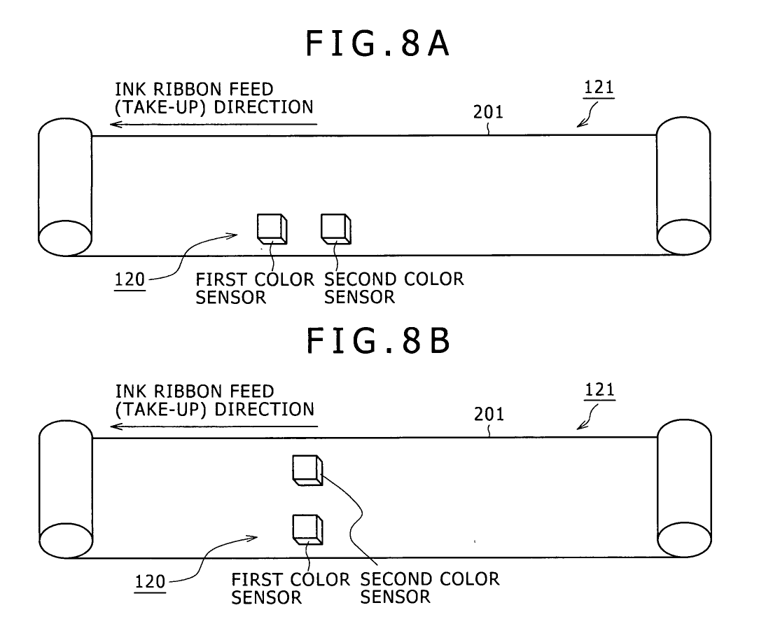

What follows is a description of the typical structures of the ink ribbon 121 along with an explanation of the corresponding structures of the mark sensor 120. The ink ribbon 121 of the three-color-coated type will be described first. FIG. 9A shows a typical ink ribbon 121 made of a base film 201 on which ink coat regions of yellow (Y), magenta (M) and cyan (C) are arrayed repeatedly, in that order.

On the ink ribbon 121, the beginning of each set of ink coat regions for single-image formation (i.e., starting position of a yellow ink coat region 202Y) is identified for detection purposes by a sensor mark SM made up of a cyan (C) ink coat 130C and a yellow (Y) ink coat 130Y arrayed in the lengthwise direction of the base film 201. Also on the ink ribbon 121, the beginning of a magenta ink coat region 202M and that of a cyan ink coat region 202C are each identified by a sensor mark SM formed by a cyan (C) ink coat 130C.

With regard to the ink ribbon 121 shown in FIG. 9A, the mark sensor 120 is constituted by a cyan (C) sensor 120C and a yellow (Y) sensor 120Y arrayed in the lengthwise direction of the base film 201. The distance between the sensor 120C and the sensor 120Y is approximately the same as the distance between the cyan (C) ink coat 130C and the yellow (Y) ink coat 130Y making up the sensor mark SM for detecting the beginning of the yellow ink coat region 202Y.

What follows is a description of the ink coats of yellow (Y), magenta (M) and cyan (C) together with an explanation of color sensors for detecting these yellow (Y), magenta (M) and cyan (C) ink coats.

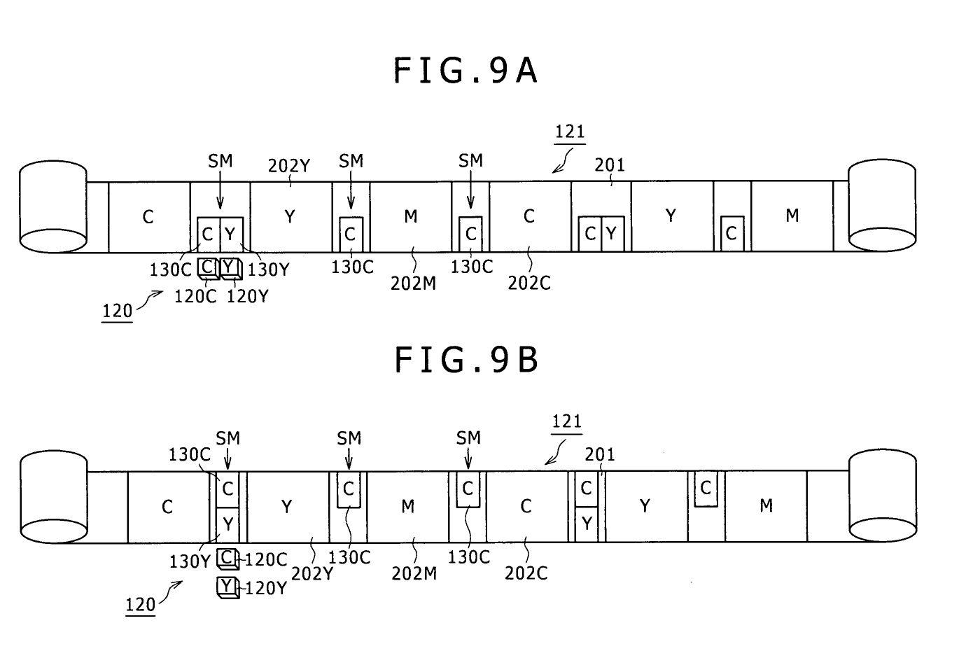

FIG. 10A shows graphically a typical transmittance characteristic of the yellow ink coat on the ink ribbon 121. FIG. 10B indicates graphically a typical transmittance characteristic of the magenta ink coat on the ink ribbon 121. FIG. 10C depicts graphically a typical transmittance characteristic of the cyan ink coat on the ink ribbon 121.

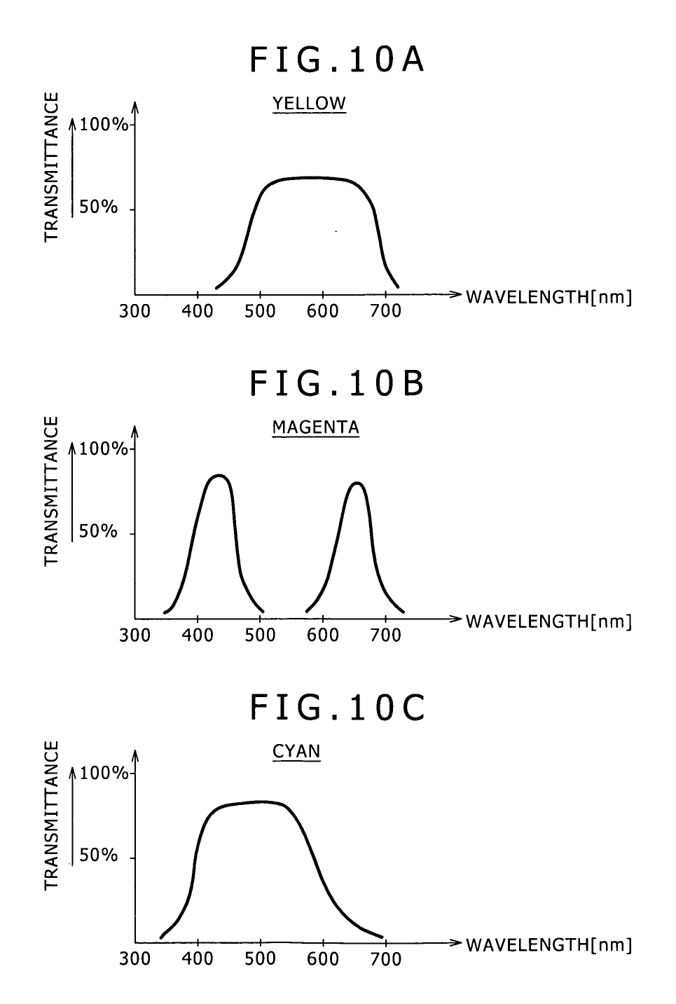

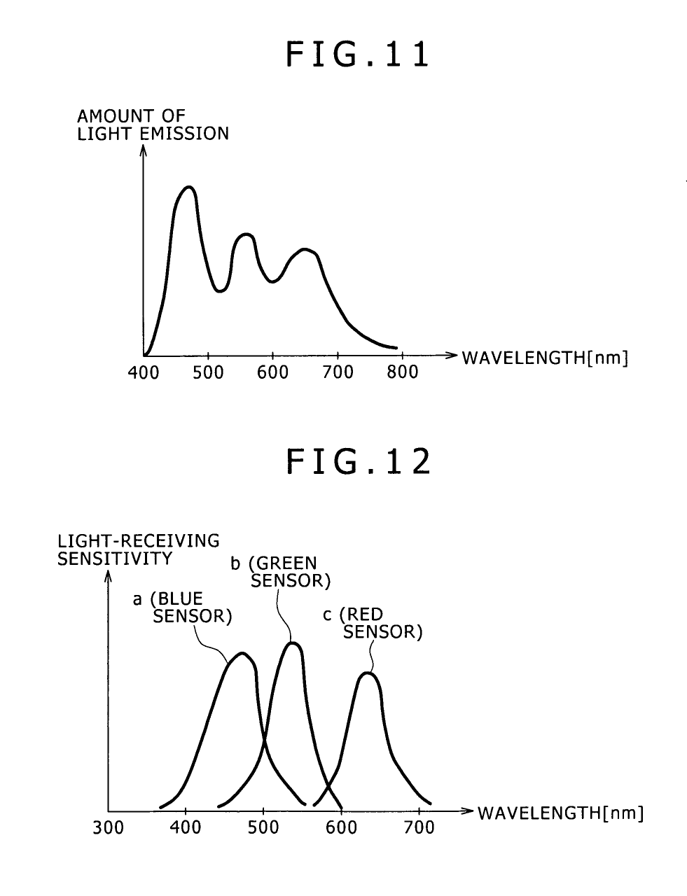

FIG. 11 illustrates graphically a typical light emission spectrum of a white LED serving as a light-emitting device. In FIG. 12, a curve “a” represents a light-receiving sensitivity characteristic of a blue sensor serving as a light-receiving device; a curve “b” denotes a light-receiving sensitivity characteristic of a green sensor acting as a light-receiving device; and a curve “c” stands for a light-receiving sensitivity characteristic of a red sensor working as a light-receiving device.

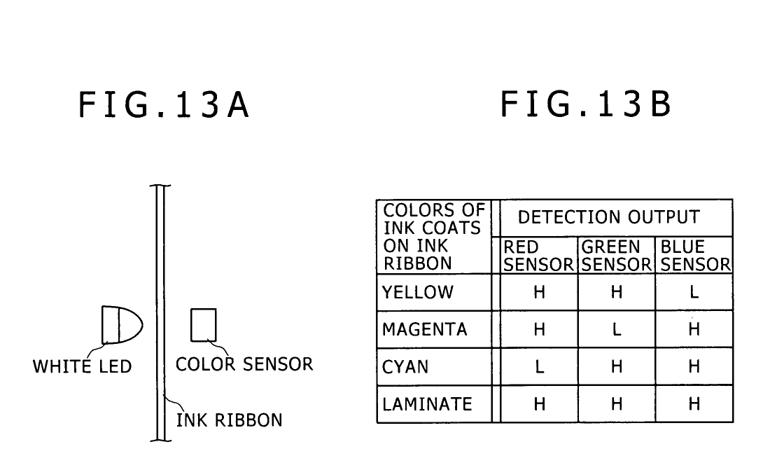

The white LED and a color sensor may be positioned opposite to each other across the ink ribbon as shown in FIG. 13A. In this setup, given the above-described sensitivity characteristics, each of the red, green and blue sensors outputs levels listed in FIG. 13B upon detection of the color ink coats of yellow (Y), magenta (M), cyan (C), and laminate (L) on the ink ribbon.

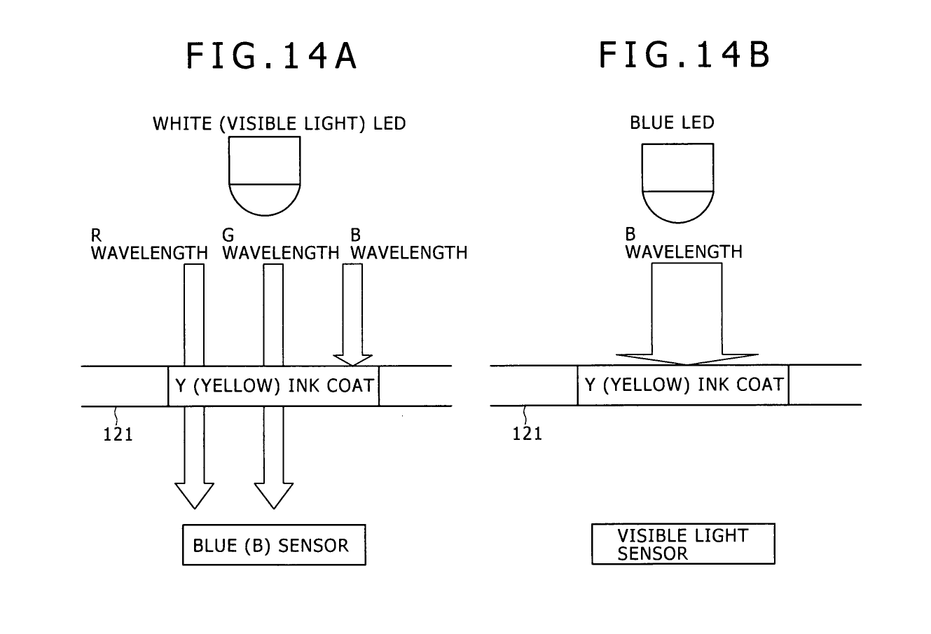

FIGS. 14A and 14B show typical yellow sensor structures for detecting the yellow ink coat on the ink ribbon 121. In FIG. 14A, a white (visible light) LED acting as a light-emitting device and a blue sensor serving as a light-receiving device are positioned opposite to each other across the ink ribbon 121.

The light emission spectrum of the white LED has wavelength components of red (R), green (G) and blue (B), as shown in FIG. 11. It should be noted here that the yellow ink coat does not let the wavelength component of blue (B) pass through as shown in FIG. 10A which graphically illustrates the transmittance characteristic of yellow. That means the blue (B) wavelength component does not reach the blue sensor across the yellow ink coat. For this reason, the detection output of the blue sensor is Low (“L”) with regard to the yellow ink coat and High (“H”) regarding the other color ink coats.

In FIG. 14B, a blue LED acting as a light-emitting device and a visible light sensor serving as a light-receiving device are positioned opposite to each other across the ink ribbon 121. The light emission spectrum of the blue LED has the wavelength component of blue (B). But the yellow ink coat does not let the wavelength component of blue (B) pass through as indicated in FIG. 10A which graphically depicts the transmittance characteristic of yellow. That means the blue (B) wavelength component does not reach the visible light sensor across the yellow ink coat. For this reason, the detection output of the visible light sensor is Low ( “L” ) with regard to the yellow ink coat and High (“H”) regarding the other color ink coats.

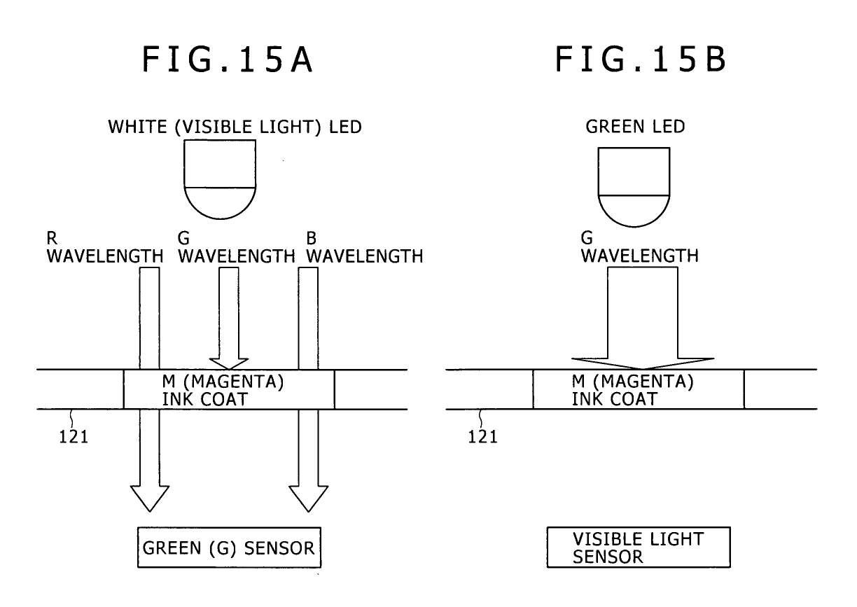

FIGS. 15A and 15B show typical magenta sensor structures for detecting the magenta ink coat on the ink ribbon 121. In FIG. 15A, a white (visible light) LED acting as a light-emitting device and a green sensor serving as a light-receiving device are positioned opposite to each other across the ink ribbon 121.

The light emission spectrum of the white LED has wavelength components of red (R), green (G) and blue (B), as shown in FIG. 11. It should be noted here that the magenta ink coat does not let the wavelength component of green (G) pass through as shown in FIG. 10B which graphically illustrates the transmittance characteristic of magenta. That means the green (G) wavelength component does not reach the green sensor across the magenta ink coat. For this reason, the detection output of the green sensor is Low (“L”) with regard to the magenta ink coat and High (“H”) regarding the other color ink coats.

In FIG. 15B, a green LED acting as a light-emitting device and a visible light sensor serving as a light-receiving device are positioned opposite to each other across the ink ribbon 121. The light emission spectrum of the green LED has the wavelength component of green (G). But the magenta ink coat does not let the wavelength component of green (G) pass through as indicated in FIG. 10B which graphically depicts the transmittance characteristic of magenta. That means the green (G) wavelength component does not reach the visible light sensor across the magenta ink coat. For this reason, the detection output of the visible light sensor is Low (“L”) with regard to the magenta ink coat and High (“H”) regarding the other color ink coats.

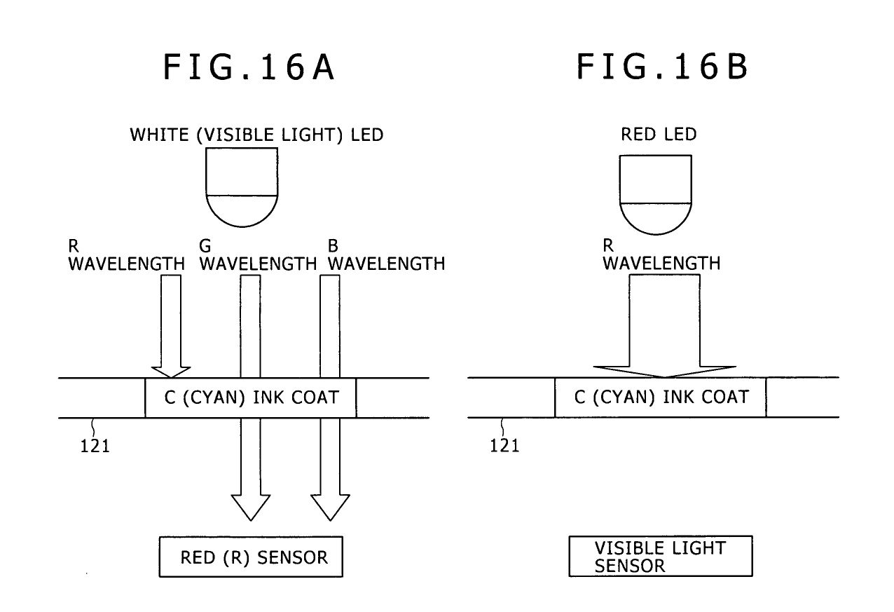

FIGS. 16A and 16B show typical cyan sensor structures for detecting the cyan ink coat on the ink ribbon 121. In FIG. 16A, a white (visible light) LED acting as a light-emitting device and a red sensor serving as a light-receiving device are positioned opposite to each other across the ink ribbon 121.

The light emission spectrum of the white LED has wavelength components of red (R), green (G) and blue (B), as shown in FIG. 11. It should be noted here that the cyan ink coat does not let the wavelength component of red (R) pass through as shown in FIG. 10C which graphically depicts the transmittance characteristic of cyan. That means the red (R) wavelength component does not reach the red sensor across the cyan ink coat. For this reason, the detection output of the red sensor is Low (“L”) with regard to the cyan ink coat and High (“H”) regarding the other color ink coats.

In FIG. 16B, a red LED acting as a light-emitting device and a visible light sensor serving as a light-receiving device are positioned opposite to each other across the ink ribbon 121. The light emission spectrum of the red LED has the wavelength component of red (R). But the cyan ink coat does not let the wavelength component of red (R) pass through as indicated in FIG. 10C which graphically depicts the transmittance characteristic of cyan. That means the red (R) wavelength component does not reach the visible light sensor across the magenta ink coat. For this reason, the detection output of the visible light sensor is Low (“L”) with regard to the cyan ink coat and High (“H”) regarding the other color ink coats.

FIG. 9B shows a typical ink ribbon 121 made of a base film 201 on which ink coat regions of yellow (Y), magenta (M) and cyan (C) are arrayed repeatedly, in that order.

On the ink ribbon 121, the beginning of each set of ink coat regions for single-image formation (i.e., starting position of a yellow ink coat region 202Y) is identified for detection purposes by a sensor mark SM made up of a yellow (Y) ink coat 130Y and a cyan (C) ink coat 130C arrayed in the crosswise direction of the base film 201. Also on the ink ribbon 121, the beginning of a magenta ink coat region 202M and that of a cyan ink coat region 202C are each identified by a sensor mark SM formed by a cyan (C) ink coat 130C.

With regard to the ink ribbon 121 shown in FIG. 9B, the mark sensor 120 is constituted by a yellow (Y) sensor 120Y and a cyan (C) sensor 120C arrayed in the crosswise direction of the base film 201. The distance between the sensor 120Y and the sensor 120C is approximately the same as the distance between the yellow (Y) ink coat 130Y and the cyan (C) ink coat 130C making up the sensor mark SM for detecting the beginning of the yellow ink coat region 202Y.

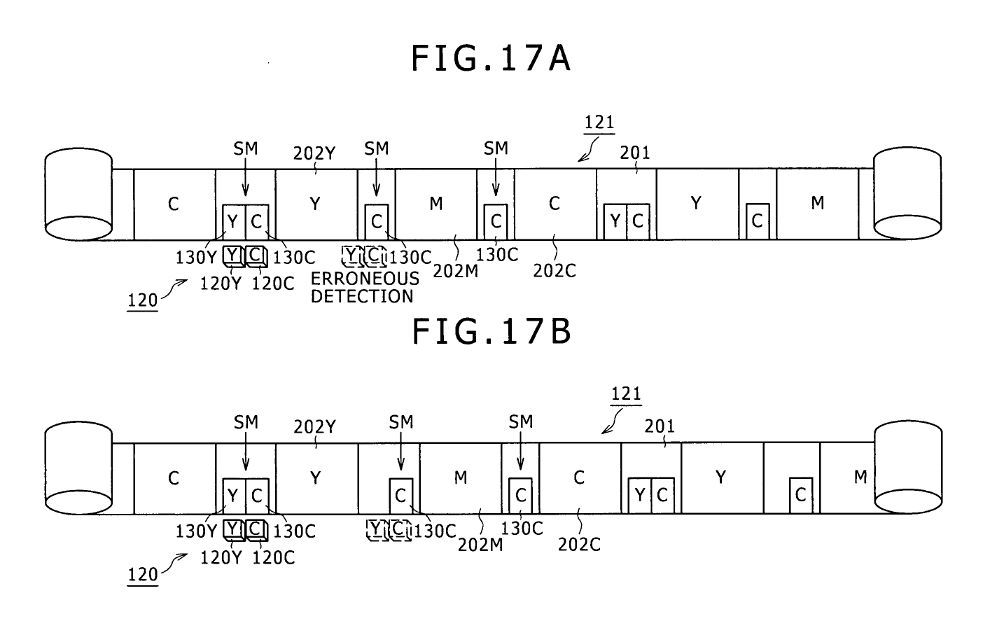

FIG. 17A shows a typical ink ribbon 121 made of a base film 201 on which ink coat regions of yellow (Y), magenta (M) and cyan (C) are arrayed repeatedly, in that order.

On the ink ribbon 121, the beginning of each set of ink coat regions for single-image formation (starting position of a yellow ink coat region 202Y) is identified for detection purposes by a sensor mark SM made up of a yellow (Y) ink coat 130Y and a cyan (C) ink coat 130C arrayed in the lengthwise direction of the base film 201. Also on the ink ribbon 121, the beginning of a magenta ink coat region 202M and that of a cyan ink coat region 202C are each identified by a sensor mark SM formed by a cyan (C) ink coat 130C.

With regard to the ink ribbon 121 shown in FIG. 17A, the mark sensor 120 is constituted by a yellow (Y) sensor 120Y and a cyan (C) sensor 120C arrayed in the lengthwise direction of the base film 201. The distance between the sensor 120Y and the sensor 120C is approximately the same as the distance between the yellow (Y) ink coat 130Y and the cyan (C) ink coat 130C making up the sensor mark SM for detecting the beginning of the yellow ink coat region 202Y.

In the structure of FIG. 17A involving the ink ribbon 121 and mark sensor 120, the detection output of the mark sensor 120 upon its arrival at the position indicated by broken lines turns out to be the same as when arriving at the position indicated by solid lines (starting position of a yellow (Y) ink coat region 202Y). This may result in erroneous detection of the broken-line-marked position as the solid-line-marked position.

Such erroneous detection is circumvented in the following manner: as shown in FIG. 17B, the distance between the yellow (Y) ink coat region 202Y on the one hand and the cyan ink coat 130C constituting the sensor mark SM for detecting the beginning of the magenta (M) ink coat region 202M on the other hand is made greater than the distance between the yellow (Y) ink coat 130Y and the cyan (C) ink coat 130C making up the sensor mark SM for detecting the beginning of the yellow ink coat region 202Y.

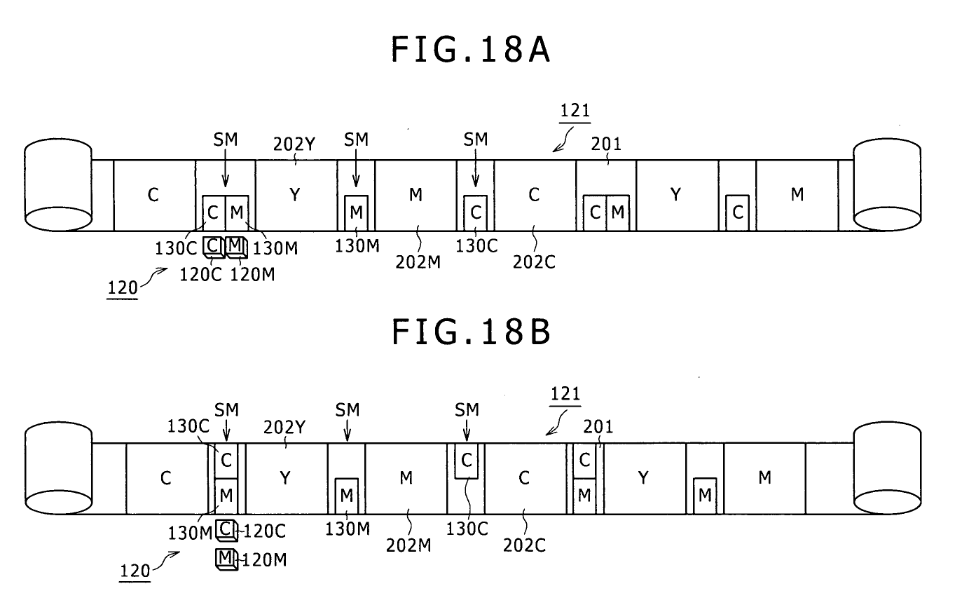

FIG. 18A shows a typical ink ribbon 121 made of a base film 201 on which ink coat regions of yellow (Y), magenta (M) and cyan (C) are arrayed repeatedly, in that order.

On the ink ribbon 121, the beginning of each set of ink coat regions for single-image formation (starting position of a yellow ink coat region 202Y) is identified for detection purposes by a sensor mark SM made up of a cyan (C) ink coat 130C and a magenta (M) ink coat 130M arrayed in the lengthwise direction of the base film 201. Also on the ink ribbon 121, the beginning of a magenta ink coat region 202M is identified by a sensor mark SM formed by a magenta (M) ink coat 130M; and the beginning of a cyan ink coat region 202C is identified by a sensor mark SM formed by a cyan (C) ink coat 130C.

With regard to the ink ribbon 121 shown in FIG. 18A, the mark sensor 120 is constituted by a cyan (C) sensor 120C and a magenta (M) sensor 120M arrayed in the lengthwise direction of the base film 201. The distance between the sensor 120C and the sensor 120M is approximately the same as the distance between the cyan (C) ink coat 130C and the magenta (M) ink coat 130M making up the sensor mark SM for detecting the beginning of the yellow ink coat region 202Y.

FIG. 18B shows a typical ink ribbon 121 made of a base film 201 on which ink coat regions of yellow (Y), magenta (M) and cyan (C) are arrayed repeatedly, in that order.

On the ink ribbon 121, the beginning of each set of ink coat regions for single-image formation (starting position of a yellow ink coat region 202Y) is identified for detection purposes by a sensor mark SM made up of a magenta (M) ink coat 130M and a cyan (C) ink coat 130C arrayed in the crosswise direction of the base film 201. Also on the ink ribbon 121, the beginning of a magenta ink coat region 202M is identified by a sensor mark SM formed by a magenta (M) ink coat 130M; and the beginning of a cyan ink coat region 202C is identified by a sensor mark SM formed by a cyan (C) ink coat 130C.

With regard to the ink ribbon 121 shown in FIG. 18B, the mark sensor 120 is constituted by a magenta (M) sensor 120M and a cyan (C) sensor 120C arrayed in the crosswise direction of the base film 201. The distance between the sensor 120M and the sensor 120C is approximately the same as the distance between the magenta (M) ink coat 130M and the cyan (C) ink coat 130C making up the sensor mark SM for detecting the beginning of the yellow ink coat region 202Y.

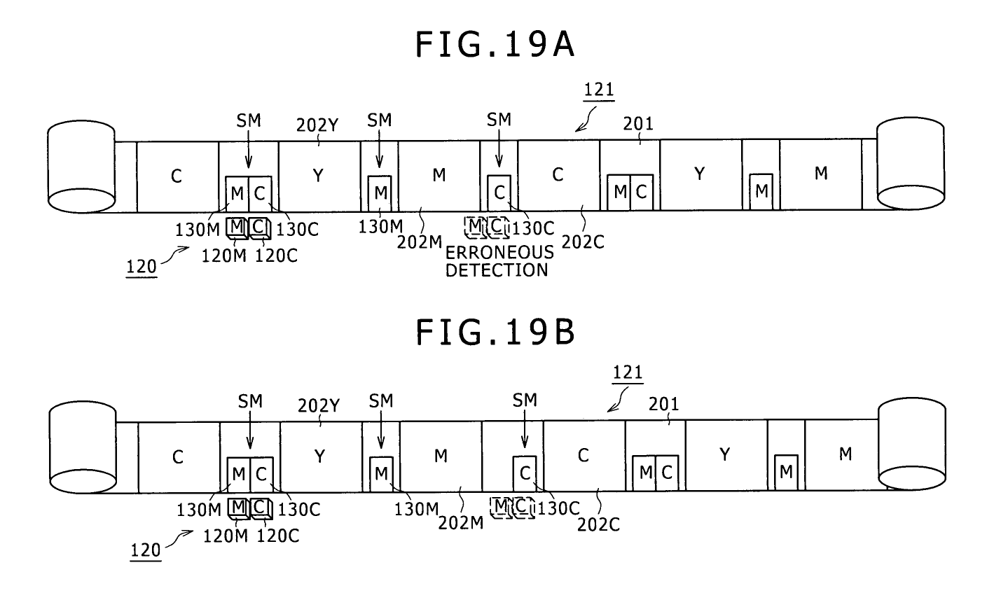

FIG. 19A shows a typical ink ribbon 121 made of a base film 201 on which ink coat regions of yellow (Y), magenta (M) and cyan (C) are arrayed repeatedly, in that order.

On the ink ribbon 121, the beginning of each set of ink coat regions for single-image formation (starting position of a yellow ink coat region 202Y) is identified for detection purposes by a sensor mark SM made up of a magenta (M) ink coat 130M and a cyan (C) ink coat 130C arrayed in the lengthwise direction of the base film 201. Also on the ink ribbon 121, the beginning of a magenta ink coat region 202M is identified by a sensor mark SM formed by a magenta (M) ink coat 130M; and the beginning of a cyan ink coat region 202C is identified by a sensor mark SM formed by a cyan (C) ink coat 130C.

With regard to the ink ribbon 121 shown in FIG. 19A, the mark sensor 120 is constituted by a magenta (M) sensor 120M and a cyan (C) sensor 120C arrayed in the lengthwise direction of the base film 201. The distance between the sensor 120M and the sensor 120C is approximately the same as the distance between the magenta (M) ink coat 130M and the cyan (C) ink coat 130C making up the sensor mark SM for detecting the beginning of the yellow ink coat region 202Y.

In the structure of FIG. 19A involving the ink ribbon 121 and mark sensor 120, the detection output of the mark sensor 120 upon its arrival at the position indicated by broken lines turns out to be the same as when arriving at the position indicated by solid lines (starting position of a yellow (Y) ink coat region 202Y). This may result in erroneous detection of the broken-line-marked position as the solid-line-marked position.

Such erroneous detection is circumvented in the following manner: as shown in FIG. 19B, the distance between the magenta (M) ink coat region 202M on the one hand and the cyan (C) ink coat 130C constituting the sensor mark SM for detecting the beginning of the cyan (C) ink coat region 202C on the other hand is made greater than the distance between the magenta (M) ink coat 130M and the cyan (C) ink coat 130C making up the sensor mark SM for detecting the yellow ink coat region 202Y.

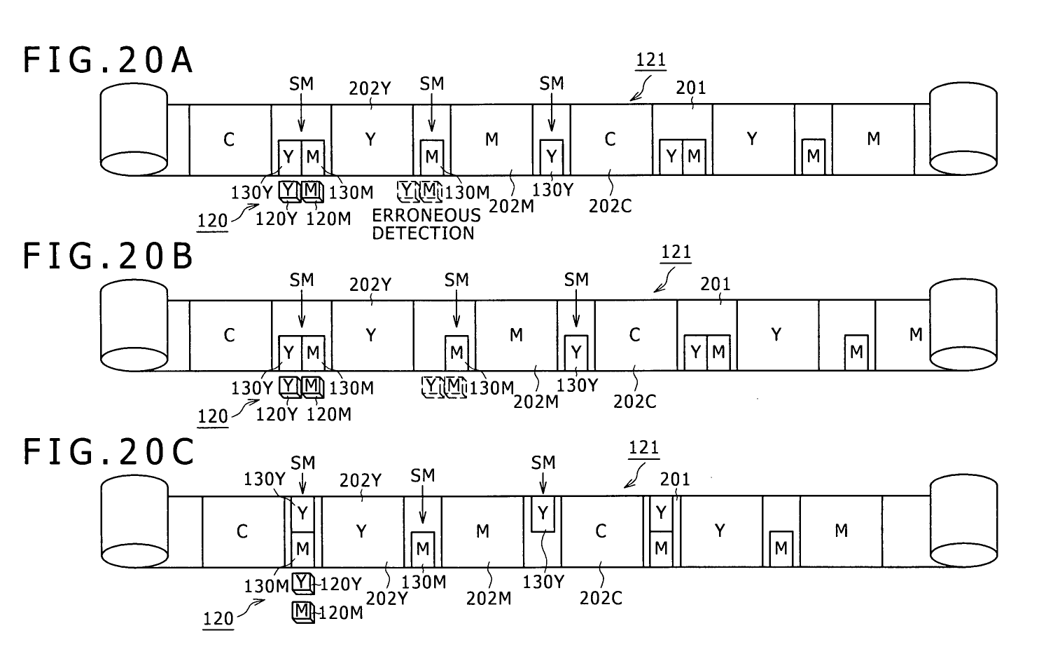

FIG. 20A shows a typical ink ribbon 121 made of a base film 201 on which ink coat regions of yellow (Y), magenta (M) and cyan (C) are arrayed repeatedly, in that order.

On the ink ribbon 121, the beginning of each set of ink coat regions for single-image formation (starting position of a yellow ink coat region 202Y) is identified for detection purposes by a sensor mark SM made up of a yellow (Y) ink coat 130Y and a magenta (M) ink coat 130M arrayed in the lengthwise direction of the base film 201. Also on the ink ribbon 121, the beginning of a magenta ink coat region 202M is identified by a sensor mark SM formed by a magenta (M) ink coat 130M; and the beginning of a cyan ink coat region 202C is identified by a sensor mark SM formed by a yellow (Y) ink coat 130Y.

With regard to the ink ribbon 121 shown in FIG. 20A, the mark sensor 120 is constituted by a yellow (Y) sensor 120Y and a magenta (M) sensor 120M arrayed in the lengthwise direction of the base film 201. The distance between the sensor 120Y and the sensor 120M is approximately the same as the distance between the yellow (Y) ink coat 130Y and the magenta (M) ink coat 130M making up the sensor mark SM for detecting the beginning of the yellow ink coat region 202Y.

In the structure of FIG. 20A involving the ink ribbon 121 and mark sensor 120, the detection output of the mark sensor 120 upon its arrival at the position indicated by broken lines turns out to be the same as when arriving at the position indicated by solid lines (starting position of a yellow (Y) ink coat region 202Y). This may result in erroneous detection of the broken-line-marked position as the solid-line-marked position.

Such erroneous detection is circumvented in the following manner: as shown in FIG. 20B, the distance between the yellow (Y) ink coat region 202Y on the one hand and the magenta (M) ink coat 130M constituting the sensor mark SM for detecting the beginning of the magenta (M) ink coat region 202M on the other hand is made greater than the distance between the yellow (Y) ink coat 130Y and the magenta (M) ink coat 130M making up the sensor mark SM for detecting the yellow ink coat region 202Y.

FIG. 20C shows a typical ink ribbon 121 made of a base film 201 on which ink coat regions of yellow (Y), magenta (M) and cyan (C) are arrayed repeatedly, in that order.

On the ink ribbon 121, the beginning of each set of ink coat regions for single-image formation (starting position of a yellow ink coat region 202Y) is identified for detection purposes by a sensor mark SM made up of a magenta (M) ink coat 130M and a yellow (Y) ink coat 130Y arrayed in the crosswise direction of the base film 201. Also on the ink ribbon 121, the beginning of a magenta ink coat region 202M is identified by a sensor mark SM formed by a magenta (M) ink coat 130M; and the beginning of a cyan ink coat region 202C is identified by a sensor mark SM formed by a yellow (Y) ink coat 130Y.

With regard to the ink ribbon 121 shown in FIG. 20C, the mark sensor 120 is constituted by a magenta (M) sensor 120M and a yellow (Y) sensor 120Y arrayed in the crosswise direction of the base film 201. The distance between the sensor 120M and the sensor 120Y is approximately the same as the distance between the magenta (M) ink coat 130M and the yellow (Y) ink coat 130Y making up the sensor mark SM for detecting the beginning of the yellow ink coat region 202Y.

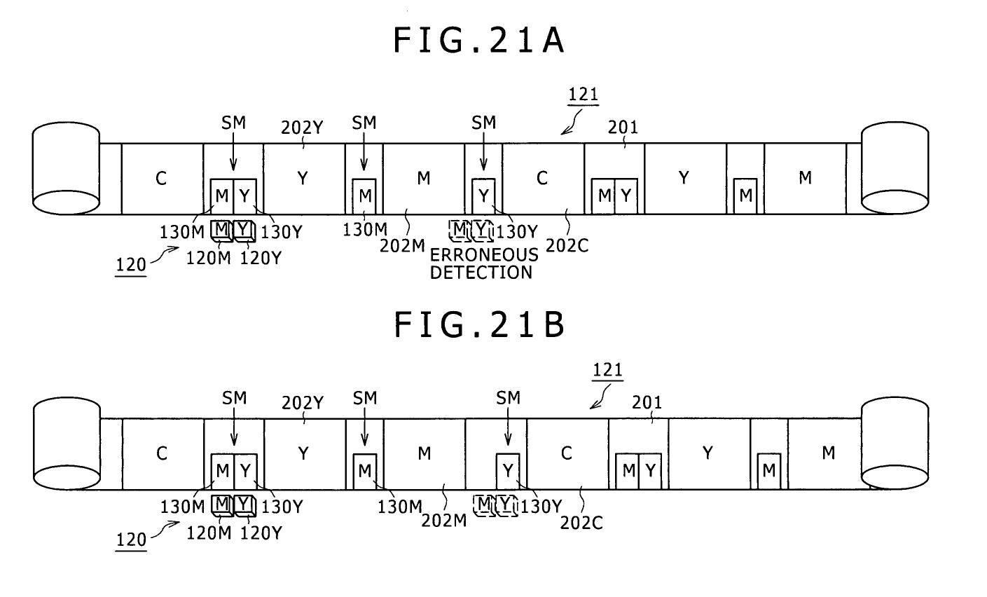

FIG. 21A shows a typical ink ribbon 121 made of a base film 201 on which ink coat regions of yellow (Y), magenta (M) and cyan (C) are arrayed repeatedly, in that order.

On the ink ribbon 121, the beginning of each set of ink coat regions for single-image formation (starting position of a yellow ink coat region 202Y) is identified for detection purposes by a sensor mark SM made up of a magenta (M) ink coat 130M and a yellow (Y) ink coat 130Y arrayed in the lengthwise direction of the base film 201. Also on the ink ribbon 121, the beginning of a magenta ink coat region 202M is identified by a sensor mark SM formed by a magenta (M) ink coat 130M; and the beginning of a cyan (C) ink coat region 202C is identified by a sensor mark SM formed by a yellow (Y) ink coat 130Y.

With regard to the ink ribbon 121 shown in FIG. 21A, the mark sensor 120 is constituted by a magenta (M) sensor 120M and a yellow (Y) sensor 120Y arrayed in the lengthwise direction of the base film 201. The distance between the sensor 120M and the sensor 120Y is approximately the same as the distance between the magenta (M) ink coat 130M and the yellow (Y) ink coat 130Y making up the sensor mark SM for detecting the beginning of the yellow ink coat region 202Y.

In the structure of FIG. 21A involving the ink ribbon 121 and mark sensor 120, the detection output of the mark sensor 120 upon its arrival at the position indicated by broken lines turns out to be the same as when arriving at the position indicated by solid lines (starting position of a yellow (Y) ink coat region 202Y). This may result in erroneous detection of the broken-line-marked position as the solid-line-marked position.

Such erroneous detection is circumvented in the following manner: as shown in FIG. 21B, the distance between the magenta (M) ink coat region 202M on the one hand and the yellow (Y) ink coat 130Y constituting the sensor mark SM for detecting the beginning of the cyan (C) ink coat region 202C on the other hand is made greater than the distance between the magenta (M) ink coat 130M and the yellow (Y) ink coat 130Y making up the sensor mark SM for detecting the yellow ink coat region 202Y.

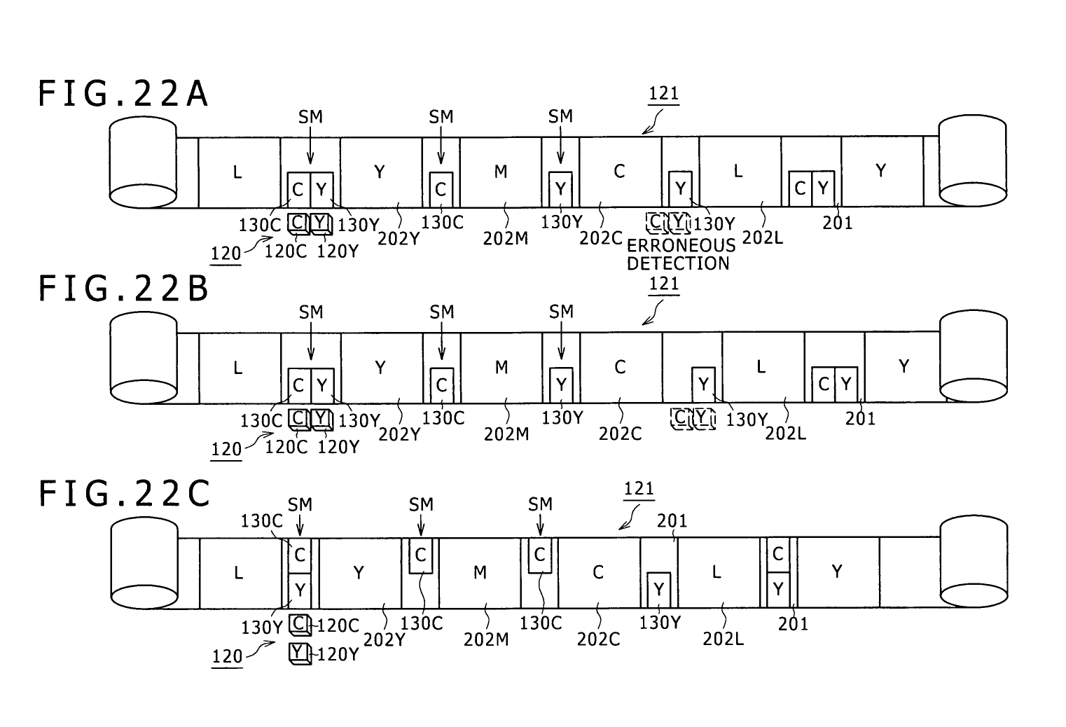

The ink ribbon 121 of the four-color-coated type will now be described. FIG. 22A shows a typical ink ribbon 121 made of a base film 201 on which ink coat regions of yellow (Y), magenta (M), cyan (C) and laminate (L) are arrayed repeatedly, in that order.

On the ink ribbon 121, the beginning of each set of ink coat regions for single-image formation (starting position of a yellow ink coat region 202Y) is identified for detection purposes by a sensor mark SM made up of a cyan (C) ink coat 130C and a yellow (Y) ink coat 130Y arrayed in the lengthwise direction of the base film 201. Also on the ink ribbon 121, the beginning of a magenta ink coat region 202M is identified by a mark sensor SM formed by a cyan (C) ink coat 130C; and the beginning of a cyan ink coat region 202C and that of a laminate ink coat region 202L are each identified by a sensor mark SM composed of a yellow (Y) ink coat 130Y.

With regard to the ink ribbon 121 shown in FIG. 22A, the mark sensor 120 is constituted by a cyan (C) sensor 120C and a yellow (Y) sensor 120Y arrayed in the lengthwise direction of the base film 201. The distance between the sensor 120C and the sensor 120Y is approximately the same as the distance between the cyan (C) ink coat 130C and the yellow (Y) ink coat 130Y making up the sensor mark SM for detecting the beginning of the yellow (Y) ink coat region 202Y.

In the structure of FIG. 22A involving the ink ribbon 121 and mark sensor 120, the detection output of the mark sensor 120 upon its arrival at the position indicated by broken lines turns out to be the same as when arriving at the position indicated by solid lines (starting position of a yellow (Y) ink coat region 202Y). This may result in erroneous detection of the broken-line-marked position as the solid-line-marked position.

Such erroneous detection is circumvented in the following manner: as shown in FIG. 22B, the distance between the cyan (C) ink coat region 202C on the one hand and the yellow (Y) ink coat 130Y constituting the sensor mark SM for detecting the beginning of the laminate (L) ink coat region 202L on the other hand is made greater than the distance between the cyan (C) ink coat 130C and the yellow (Y) ink coat 130Y making up the sensor mark SM for detecting the beginning of the yellow ink coat region 202Y.

FIG. 22C shows a typical ink ribbon 121 made of a base film 201 on which ink coat regions of yellow (Y), magenta (M), cyan (C) and laminate (L) are arrayed repeatedly, in that order.

On the ink ribbon 121, the beginning of each set of ink coat regions for single-image formation (starting position of a yellow ink coat region 202Y) is identified for detection purposes by a sensor mark SM made up of a yellow (Y) ink coat 130Y and a cyan (C) ink coat 130C arrayed in the crosswise direction of the base film 201. Also on the ink ribbon 121, the beginning of a magenta ink coat region 202M and that of a cyan ink coat region 202C are each identified by a sensor mark SM formed by a cyan (C) ink coat 130C; and the beginning of a laminate ink coat region 202L is identified by a sensor mark SM formed by a yellow (Y) ink coat 130Y.

With regard to the ink ribbon 121 shown in FIG. 22C, the mark sensor 120 is constituted by a yellow (Y) sensor 120Y and a cyan (C) sensor 120C arrayed in the crosswise direction of the base film 201. The distance between the sensor 120Y and the sensor 120C is approximately the same as the distance between the yellow (Y) ink coat 130Y and the cyan (C) ink coat 130C making up the sensor mark SM for detecting the beginning of the yellow ink coat region 202Y.

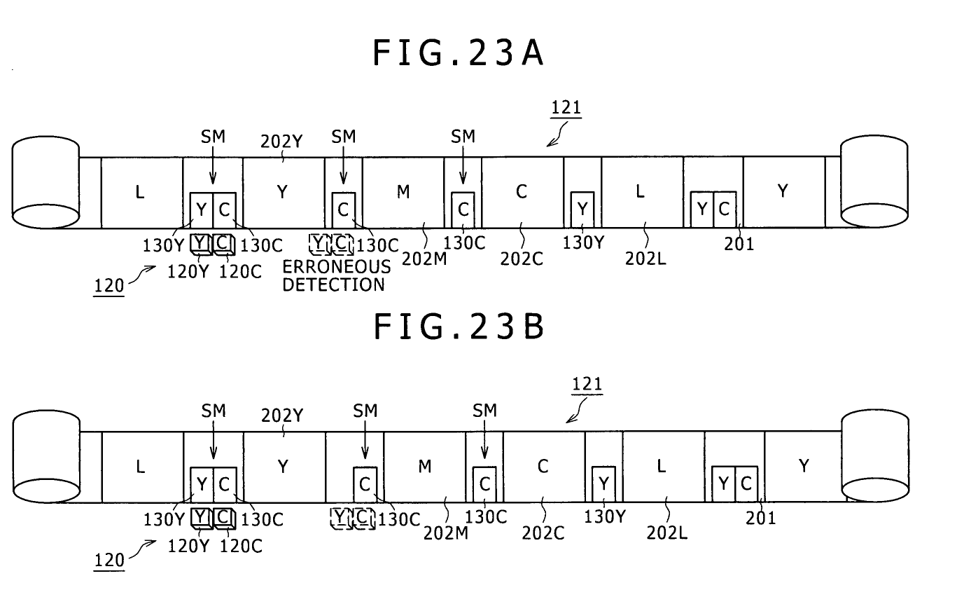

FIG. 23A shows a typical ink ribbon 121 made of a base film 201 on which ink coat regions of yellow (Y), magenta (M), cyan (C) and laminate (L) are arrayed repeatedly, in that order.

On the ink ribbon 121, the beginning of each set of ink coat regions for single-image formation (starting position of a yellow ink coat region 202Y) is identified for detection purposes by a sensor mark SM made up of a yellow (Y) ink coat 130Y and a cyan (C) ink coat 130C arrayed in the lengthwise direction of the base film 201. Also on the ink ribbon 121, the beginning of a magenta ink coat region 202M and that of a cyan ink coat region 202C are each identified by a sensor mark SM formed by a cyan (C) ink coat 130C; and the beginning of a laminate ink coat region 202L is identified by a sensor mark SM formed by a yellow (Y) ink coat 130Y.

With regard to the ink ribbon 121 shown in FIG. 23A, the mark sensor 120 is constituted by a yellow (Y) sensor 120Y and a cyan (C) sensor 120C arrayed in the lengthwise direction of the base film 201. The distance between the sensor 120Y and the sensor 120C is approximately the same as the distance between the yellow (Y) ink coat 130Y and the cyan (C) ink coat 130C making up the sensor mark SM for detecting the beginning of the yellow ink coat region 202Y.

In the structure of FIG. 23A involving the ink ribbon 121 and mark sensor 120, the detection output of the mark sensor 120 upon its arrival at the position indicated by broken lines turns out to be the same as when arriving at the position indicated by solid lines (starting position of a yellow (Y) ink coat region 202Y). This may result in erroneous detection of the broken-line-marked position as the solid-line-marked position.

Such erroneous detection is circumvented in the following manner: as shown in FIG. 23B, the distance between the yellow (Y) ink coat region 202Y on the one hand and the cyan (C) ink coat 130C constituting the sensor mark SM for detecting the beginning of the magenta (M) ink coat region 202M on the other hand is made greater than the distance between the yellow (Y) ink coat 130Y and the cyan (C) ink coat 130C making up the sensor mark SM for detecting the beginning of the yellow ink coat region 202Y.

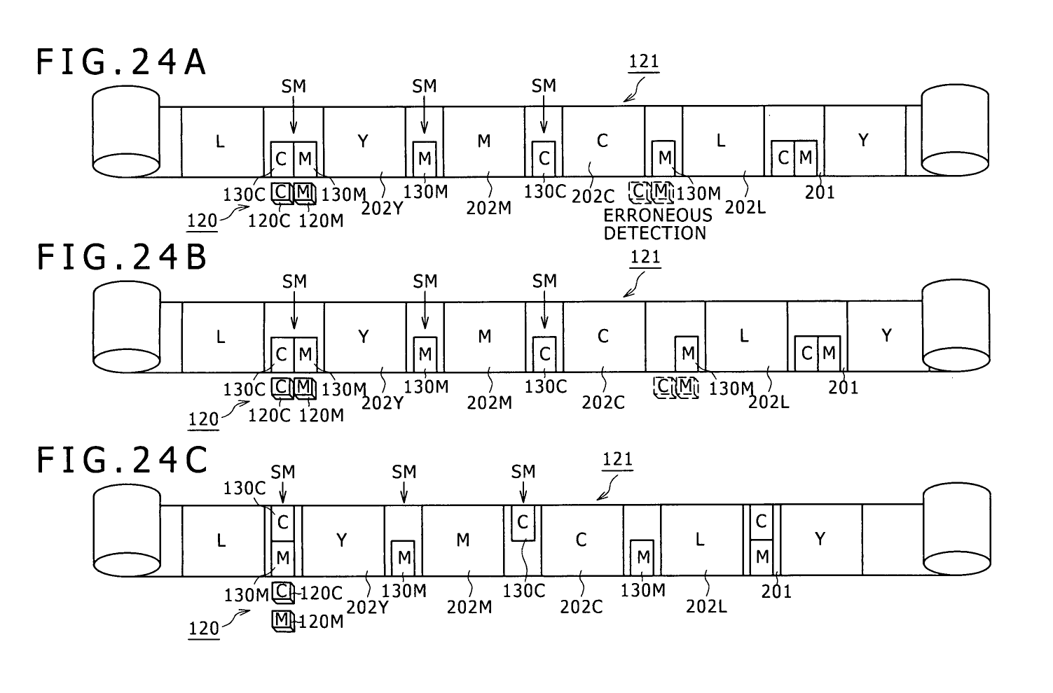

FIG. 24A shows a typical ink ribbon 121 made of a base film 201 on which ink coat regions of yellow (Y), magenta (M), cyan (C) and laminate (L) are arrayed repeatedly, in that order.

On the ink ribbon 121, the beginning of each set of ink coat regions for single-image formation (starting position of a yellow ink coat region 202Y) is identified for detection purposes by a sensor mark SM made up of a cyan (C) ink coat 130C and a magenta (M) ink coat 130M arrayed in the lengthwise direction of the base film 201. Also on the ink ribbon 121, the beginning of a magenta ink coat region 202M is identified by a sensor mark SM formed by a magenta (M) ink coat 130M; the beginning of a cyan ink coat region 202C is identified by a sensor marker SM constituted by a cyan (C) ink coat 130C; and the beginning of a laminate ink coat region 202L is identified by a sensor mark SM composed of a magenta (M) ink coat 130M.

With regard to the ink ribbon 121 shown in FIG. 24A, the mark sensor 120 is constituted by a cyan (C) sensor 120C and a magenta (M) sensor 120M arrayed in the lengthwise direction of the base film 201. The distance between the sensor 120C and the sensor 120M is approximately the same as the distance between the cyan (C) ink coat 130C and the magenta (M) ink coat 130M making up the sensor mark SM for detecting the beginning of the yellow ink coat region 202Y.

In the structure of FIG. 24A involving the ink ribbon 121 and mark sensor 120, the detection output of the mark sensor 120 upon its arrival at the position indicated by broken lines turns out to be the same as when arriving at the position indicated by solid lines (starting position of a yellow (Y) ink coat region 202Y). This may result in erroneous detection of the broken-line-marked position as the solid-line-marked position.

Such erroneous detection is circumvented in the following manner: as shown in FIG. 24B, the distance between the cyan (C) ink coat region 202C on the one hand and the magenta (M) ink coat 130M constituting the sensor mark SM for detecting the beginning of the laminate (L) ink coat region 202L on the other hand is made greater than the distance between the cyan (C) ink coat 130C and the magenta (M) ink coat 130M making up the sensor mark SM for detecting the beginning of the yellow ink coat region 202Y.

FIG. 24C shows a typical ink ribbon 121 made of a base film 201 on which ink coat regions of yellow (Y), magenta (M), cyan (C) and laminate (L) are arrayed repeatedly, in that order.

On the ink ribbon 121, the beginning of each set of ink coat regions for single-image formation (starting position of a yellow ink coat region 202Y) is identified for detection purposes by a sensor mark SM made up of a magenta (M) ink coat 130M and a cyan (C) ink coat 130C arrayed in the crosswise direction of the base film 201. Also on the ink ribbon 121, the beginning of a magenta ink coat region 202M is identified by a sensor mark SM formed by a magenta (M) ink coat 130M; the beginning of a cyan ink coat region 202C is identified by a sensor marker SM constituted by-a cyan (C) ink coat 130C; and the beginning of a laminate ink coat region 202L is identified by a sensor mark SM composed of a magenta (M) ink coat 130M.

With regard to the ink ribbon 121 shown in FIG. 24C, the mark sensor 120 is constituted by a magenta (M) sensor 120M and a cyan (C) sensor 120C arrayed in the crosswise direction of the base film 201. The distance between the sensor 120M and the sensor 120C is approximately the same as the distance between the magenta (M) ink coat 130M and the cyan (C) ink coat 130C making up the sensor mark SM for detecting the beginning of the yellow ink coat region 202Y.

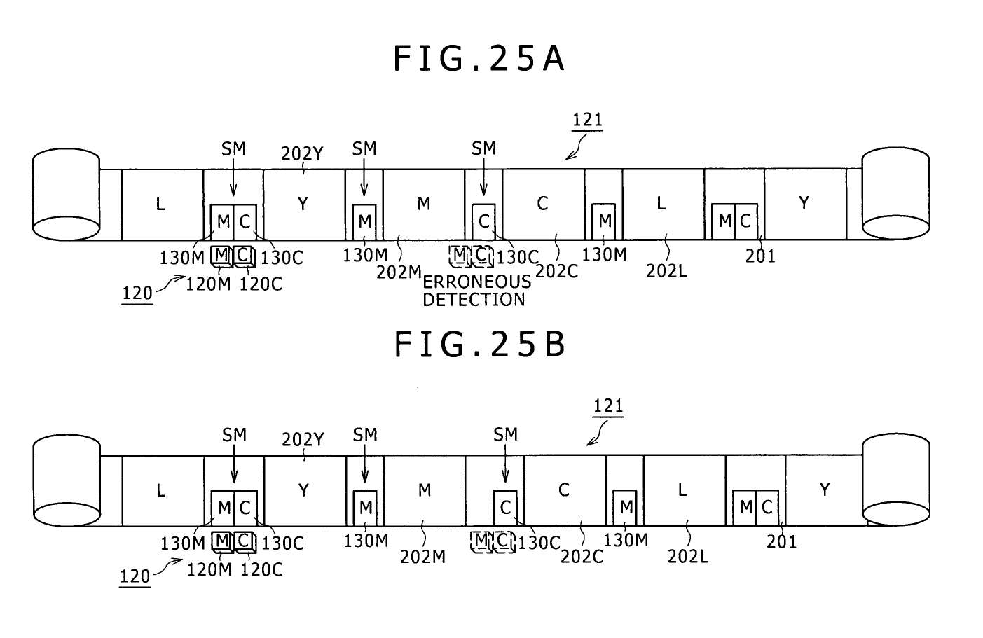

FIG. 25A shows a typical ink ribbon 121 made of a base film 201 on which ink coat regions of yellow (Y), magenta (M), cyan (C) and laminate (L) are arrayed repeatedly, in that order.

On the ink ribbon 121, the beginning of each set of ink coat regions for single-image formation (starting position of a yellow ink coat region 202Y) is identified for detection purposes by a sensor mark SM made up of a magenta (M) ink coat 130M and a cyan (C) ink coat 130C arrayed in the lengthwise direction of the base film 201. Also on the ink ribbon 121, the beginning of a magenta ink coat region 202M is identified by a sensor mark SM formed by a magenta (M) ink coat 130M; the beginning of a cyan ink coat region 202C is identified by a sensor marker SM constituted by a cyan (C) ink coat 130C; and the beginning of a laminate ink coat region 202L is identified by a sensor mark SM composed of a magenta (M) ink coat 130M.

With regard to the ink ribbon 121 shown in FIG. 25A, the mark sensor 120 is constituted by a magenta (M) sensor 120M and a cyan (C) sensor 120C arrayed in the lengthwise direction of the base film 201. The distance between the sensor 120M and the sensor 120C is approximately the same as the distance between the magenta (M) ink coat 130M and the cyan (C) ink coat 130C making up the sensor mark SM for detecting the beginning of the yellow ink coat region 202Y.

In the structure of FIG. 25A involving the ink ribbon 121 and mark sensor 120, the detection output of the mark sensor 120 upon its arrival at the position indicated by broken lines turns out to be the same as when arriving at the position indicated by solid lines (starting position of a yellow (Y) ink coat region 202Y). This may result in erroneous detection of the broken-line-marked position as the solid-line-marked position.

Such erroneous detection is circumvented in the following manner: as shown in FIG. 25B, the distance between the magenta (M) ink coat region 202M on the one hand and the cyan (C) ink coat 130C constituting the sensor mark SM for detecting the beginning of the cyan (C) ink coat region 202C on the other hand is made greater than the distance between the magenta (M) ink coat 130M and the cyan (C) ink coat 130C making up the sensor mark SM for detecting the beginning of the yellow ink coat region 202Y.

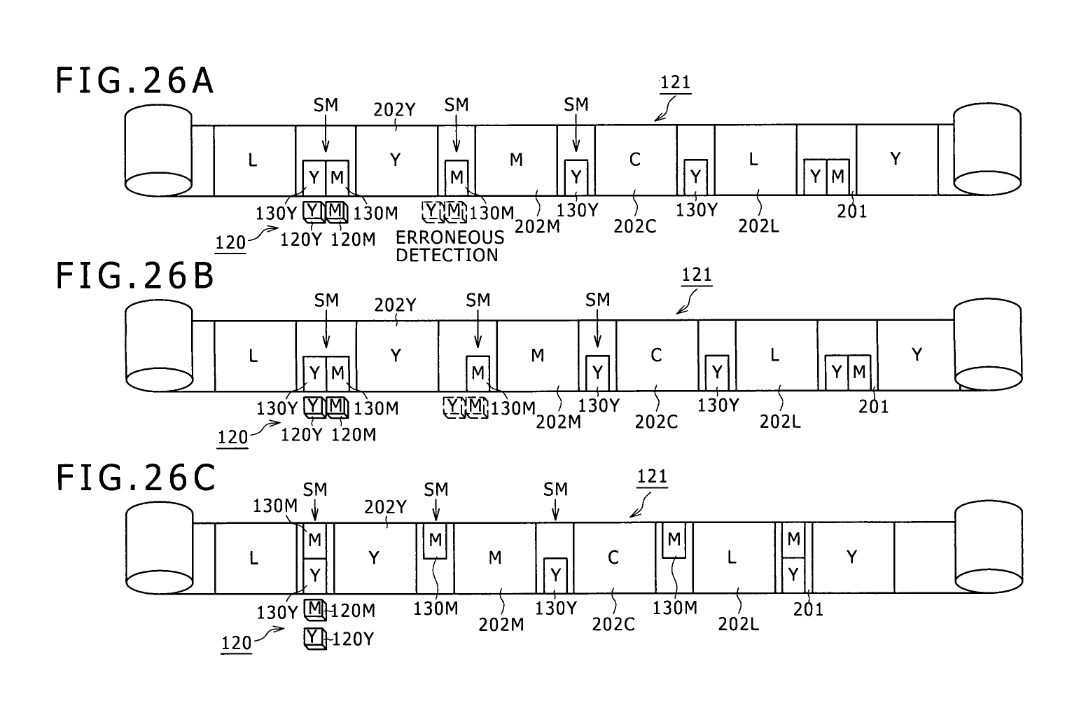

FIG. 26A shows a typical ink ribbon 121 made of a base film 201 on which ink coat regions of yellow (Y), magenta (M), cyan (C) and laminate (L) are arrayed repeatedly, in that order.

On the ink ribbon 121, the beginning of each set of ink coat regions for single-image formation (starting position of a yellow ink coat region 202Y) is identified for detection purposes by a sensor mark SM made up of a yellow (Y) ink coat 130Y and a magenta (M) ink coat 130M arrayed in the lengthwise direction of the base film 201. Also on the ink ribbon 121, the beginning of a magenta ink coat region 202M is identified by a sensor mark SM formed by a magenta (M) ink coat 130M; the beginning of a cyan ink coat region 202C is identified by a sensor marker SM constituted by a yellow (Y) ink coat 130Y; and the beginning of a laminate ink coat region 202L is identified by a sensor mark SM composed of a yellow (Y) ink coat 130Y.

With regard to the ink ribbon 121 shown in FIG. 26A, the mark sensor 120 is constituted by a yellow (Y) sensor 120Y and a magenta (M) sensor 120M arrayed in the lengthwise direction of the base film 201. The distance between the sensor 120Y and the sensor 120M is approximately the same as the distance between the yellow (Y) ink coat 130Y and the magenta (M) ink coat 130M making up the sensor mark SM for detecting the beginning of the yellow ink coat region 202Y.

In the structure of FIG. 26A involving the ink ribbon 121 and mark sensor 120, the detection output of the mark sensor 120 upon its arrival at the position indicated by broken lines turns out to be the same as when arriving at the position indicated by solid lines (starting position of a yellow (Y) ink coat region 202Y). This may result in erroneous detection of the broken-line-marked position as the solid-line-marked position.

Such erroneous detection is circumvented in the following manner: as shown in FIG. 26B, the distance between the yellow (Y) ink coat region 202Y on the one hand and the magenta (M) ink coat 130M constituting the sensor mark SM for detecting the beginning of a magenta (M) ink coat region 202M on the other hand is made greater than the distance between the yellow (Y) ink coat 130Y and the magenta (M) ink coat 130M making up the sensor mark SM for detecting the beginning of the yellow ink coat region 202Y.

FIG. 26C shows a typical ink ribbon 121 made of a base film 201 on which ink coat regions of yellow (Y), magenta (M), cyan (C) and laminate (L) are arrayed repeatedly, in that order.

On the ink ribbon 121, the beginning of each set of ink coat regions for single-image formation (starting position of a yellow ink coat region 202Y) is identified for detection purposes by a sensor mark SM made up of a yellow (Y) ink coat 130Y and a magenta (M) ink coat 130M arrayed in the crosswise direction of the base film 201. Also on the ink ribbon 121, the beginning of a magenta ink coat region 202M is identified by a sensor mark SM formed by a magenta (M) ink coat 130M; the beginning of a cyan ink coat region 202C is identified by a sensor marker SM constituted by a yellow (Y) ink coat 130Y; and the beginning of a laminate ink coat region 202L is identified by a sensor mark SM composed of a magenta (M) ink coat 130M.

With regard to the ink ribbon 121 shown in FIG. 26C, the mark sensor 120 is constituted by a yellow (Y) sensor 120Y and a magenta (M) sensor 120M arrayed in the crosswise direction of the base film 201. The distance between the sensor 120Y and the sensor 120M is approximately the same as the distance between the yellow (Y) ink coat 130Y and the magenta (M) ink coat 130M making up the sensor mark SM for detecting the beginning of the yellow ink coat region 202Y.

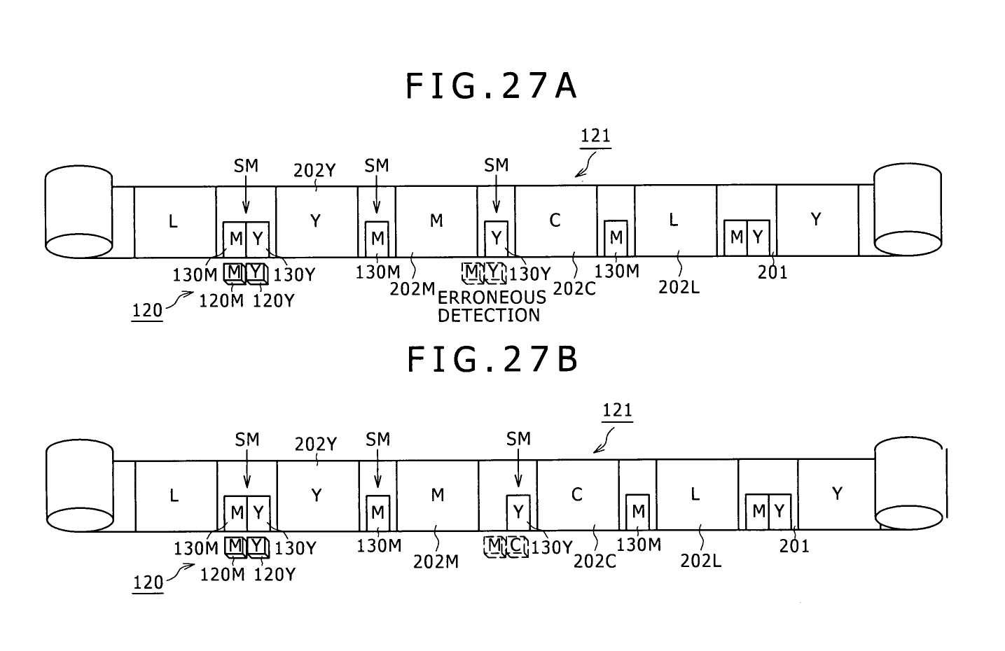

FIG. 27A shows a typical ink ribbon 121 made of a base film 201 on which ink coat regions of yellow (Y), magenta (M), cyan (C) and laminate (L) are arrayed repeatedly, in that order.

On the ink ribbon 121, the beginning of each set of ink coat regions for single-image formation (starting position of a yellow ink coat region 202Y) is identified for detection purposes by a sensor mark SM made up of a magenta (M) ink coat 130M and a yellow (Y) ink coat 130Y arrayed in the lengthwise direction of the base film 201. Also on the ink ribbon 121, the beginning of a magenta ink coat region 202M is identified by a sensor mark SM formed by a magenta (M) ink coat 130M; the beginning of a cyan ink coat region 202C is identified by a sensor marker SM constituted by a yellow (Y) ink coat 130Y; and the beginning of a laminate ink coat region 202L is identified by a sensor mark SM composed of a magenta (M) ink coat 130M.

With regard to the ink ribbon 121 shown in FIG. 27A, the mark sensor 120 is constituted by a magenta (M) sensor 120M and a yellow (Y) sensor 120Y arrayed in the lengthwise direction of the base film 201. The distance between the sensor 120M and the sensor 120Y is approximately the same as the distance between the magenta (M) ink coat 130M and the yellow (Y) ink coat 130Y making up the sensor mark SM for detecting the beginning of the yellow ink coat region 202Y.

In the structure of FIG. 27A involving the ink ribbon 121 and mark sensor 120, the detection output of the mark sensor 120 upon its arrival at the position indicated by broken lines turns out to be the same as when arriving at the position indicated by solid lines (starting position of a yellow (Y) ink coat region 202Y). This may result in erroneous detection of the broken-line-marked position as the solid-line-marked position.

Such erroneous detection is circumvented in the following manner: as shown in FIG. 27B, the distance between the magenta (M) ink coat region 202M on the one hand and the yellow (Y) ink coat 130Y constituting the sensor mark SM for detecting the beginning of a cyan (C) ink coat region 202C on the other hand is made greater than the distance between the magenta (M) ink coat 130M and the yellow (Y) ink coat 130Y making up the sensor mark SM for detecting the beginning of the yellow ink coat region 202Y.

In the above-described typical structures involving the ink ribbon 121 and mark sensor 120, the ink coat regions are arrayed repeatedly either in the order of yellow (Y), magenta (M) and cyan (C), or in the order of yellow (Y), magenta (M), cyan (C) and laminate (L) on the base film 201. Alternatively, the ink coat regions may be arrayed in different orders of colors (see FIGS. 6A through 7F) and may still be addressed properly by the inventive arrangements.

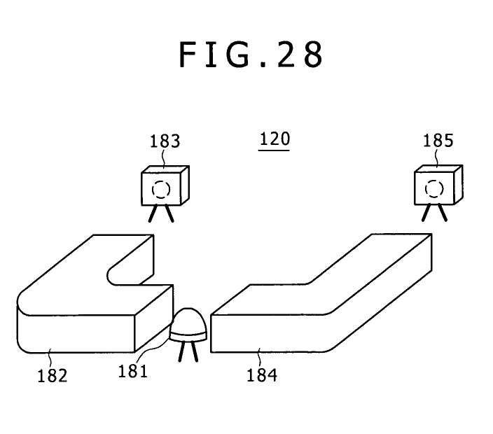

FIG. 28 schematically shows a typical structure of the mark sensor 120 indicated in FIG. 9A. The mark sensor 120 is shown to include a white LED 181 serving as a light-emitting device, a light guide 182, a red sensor 183, a light guide 184, and a blue sensor 185.

The white LED 181, light guide 182, and red sensor 183 make up the cyan sensor (see FIG. 16A). The color wavelength components of red (R), green (G) and blue (B) are guided by the light guide 182 into the red sensor 183. In this setup, if there is a cyan (C) ink coat of the ink ribbon 121 interposed between the light guide 182 and the red sensor 183, the wavelength component of red (R) does not reach the red sensor 183. For this reason, the detection output of the red sensor 183 is Low ( “L” ) with regard to the cyan ink coat and High (“H”) regarding the ink coats of the other colors.

The white LED 181, light guide 184, and blue sensor 185 make up the yellow sensor (see FIG. 14A). The color wavelength components of red (R), green (G) and blue (B) are guided by the light guide 184 into the blue sensor 185. In this setup, if there is a yellow (Y) ink coat of the ink ribbon 121 interposed between the light guide 184 and the blue sensor 185, the wavelength component of blue (B) does not reach the blue sensor 185. For this reason, the detection output of the blue sensor 185 is Low (“L”) with regard to the yellow ink coat and High (“H”) regarding the ink coats of the other colors.

The mark sensor 120 shown in FIG. 28 utilizes the light guides 182 and 184 in conjunction with only a single white LED as the light-emitting device. These components constitute a small, low-cost mark sensor structure. The mark sensor structure in FIG. 28 obviously applies to the mark sensor structured with the sensor of another color as well.

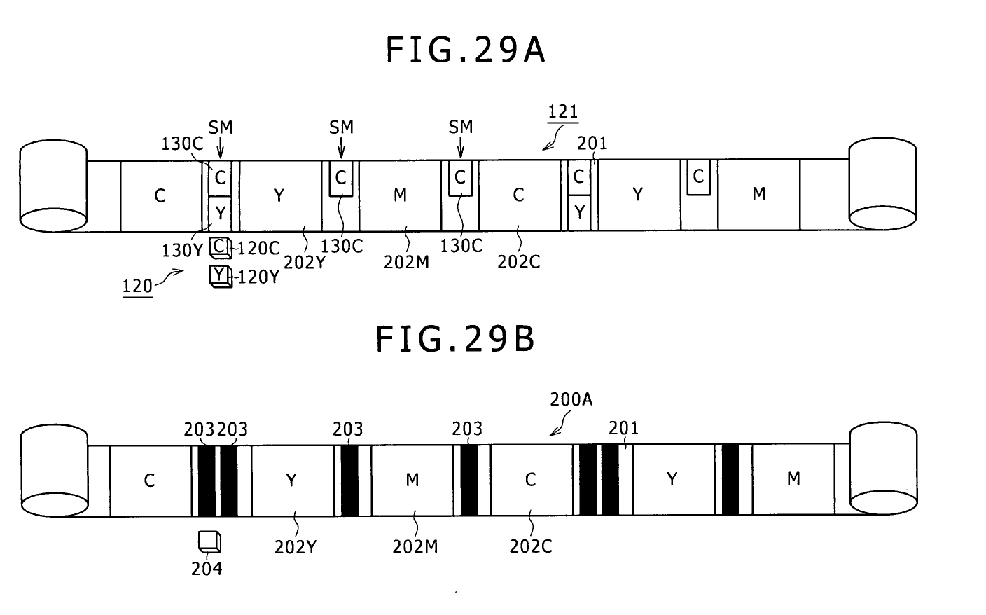

What follows is a description of how the printer 100 shown in FIG. 1, with the ink ribbon 121 and mark sensor 120 structured as discussed above, works to detect the beginning of one set of ink coat regions for making up a single image (i.e., how the printer 100 operates to detect the starting position of the first of the ink coat regions for single-image formation). It is assumed that the ink ribbon 121 and mark sensor 120 are structured as shown in FIG. 29A, i.e., the same setup as in FIG. 9B described earlier.

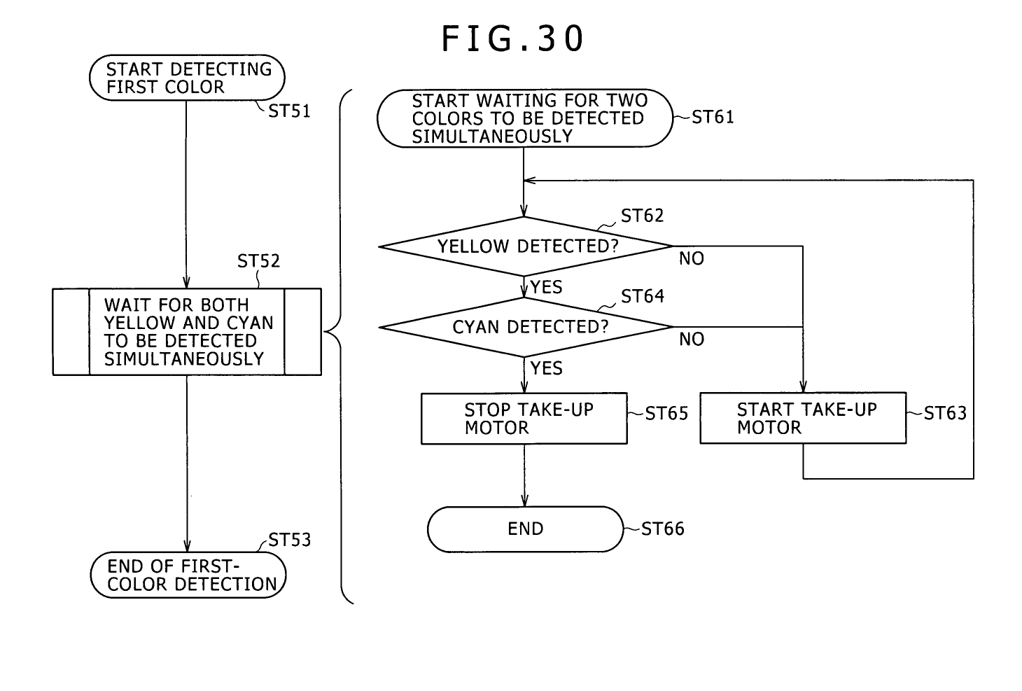

FIG. 30 is a flowchart of steps outlining how the beginning of the first color (i.e., ink coat region of yellow (Y)) is detected based on the detection output of the mark sensor 120.

In step ST51, the print control block 106 starts the process of detecting the first color. In step ST52, the print control block 106 waits for yellow (Y) and cyan (C) to be detected simultaneously. Upon simultaneous detection of the two colors in step ST52, the print control block 106 goes to step ST53 and terminates the first-color detecting process.

Step ST52 includes the following detailed steps: In step ST61, the print control block 106 starts the process of waiting for the two colors to be detected simultaneously. In step ST62, the print control block 106 checks to determine whether a yellow (Y) ink coat 130Y is detected based on the detection output of the yellow sensor.

If in step ST62 a yellow (Y) ink coat 130Y is not found to be detected, the print control block 106 goes to step ST63 and starts the take-up motor 116. The print control block 106 then returns to step ST62. If a yellow (Y) ink coat 130Y is found to be detected in step ST62, then the print control block 106 goes to step ST64.

In step ST64, the print control block 106 checks to determine whether a cyan (C) ink coat 130C is detected based on the detection output of the cyan sensor. If in step ST64 a cyan (C) ink coat 130C is not found to be detected, the print control block 106 goes to step ST63 and starts the take-up motor 116. The print control block 106 then returns to step ST62.

If in step ST64 a cyan (C) ink coat 130C is found to be detected, the print control block 106 goes to step ST65 and stops the take-up motor 116. The print control block 106 then goes to step ST66 and terminates the process of waiting for the two colors to be detected simultaneously.

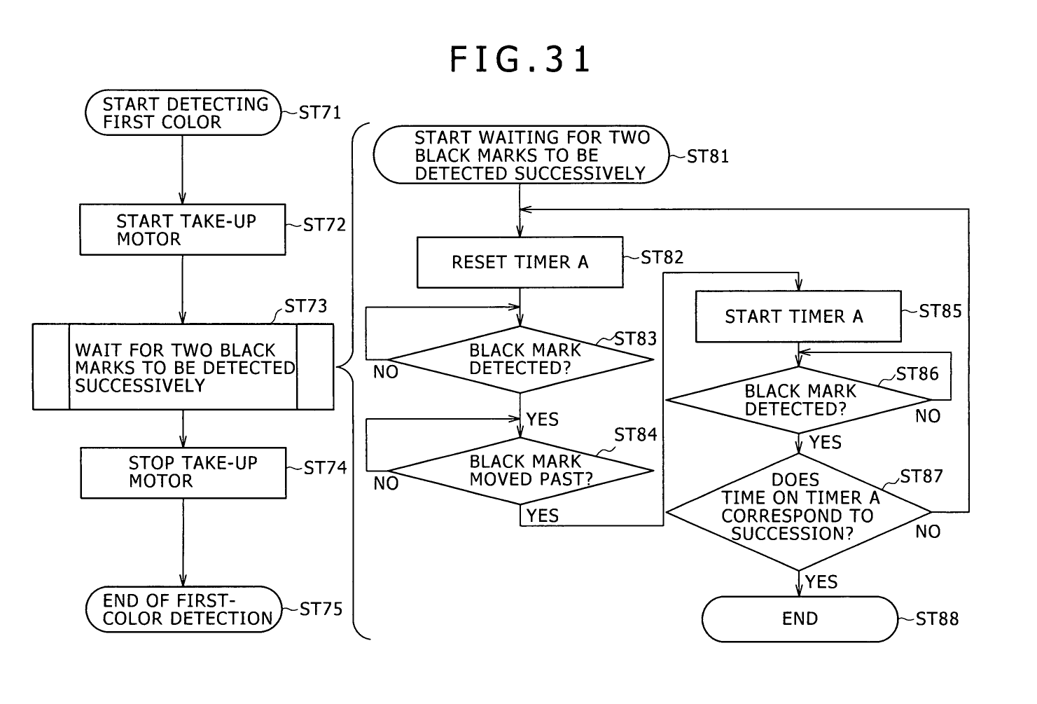

FIG. 29B schematically shows black marks 203 formed on an ordinary ink ribbon 200A, along with a mark sensor 204. The flowchart of steps in FIG. 31 outlines how the beginning of the first color (i.e., ink coat region of yellow (Y)) is detected traditionally by the print control block of an ordinary printer based on the detection output of the mark sensor 204.

In step ST71, the print control block starts the process of detecting the first color. In step ST72, the print control block starts the take-up motor. Step ST72 is followed by step ST73 in which the print control block waits for two black marks 203 to be detected in succession.

If in step ST73 two block marks 203 are found to be detected successively, the print control block goes to step ST74 and stops the take-up motor. In step ST75, the print control block terminates the first color detecting process.

Step ST73 includes the following detailed steps: In step ST81, the print control block starts the process of waiting for two black marks to be detected in succession. In step ST82, the print control block resets a timer A and goes to step ST83. In step ST83, the print control block checks to determine whether a black mark 203 is detected based on the detection output of the mark sensor 204.

Upon detection of the black mark 203 in step ST83, the print control block goes to step ST84. In step ST84, the print control block checks to determine whether the black mark has moved past based on the detection output of the mark sensor 204. If in step ST84 the black mark 203 is found to have moved past, the print control block goes to step ST85 and starts the timer A. Step ST85 is followed by step ST86

In step ST86, the print control block checks to determine whether another black mark 203 is detected based on the detection output of the mark sensor 204. Upon detection of the black mark 203 in step ST86, the print control block goes to step ST87 and checks to determine whether the time counted on the timer A corresponds to a succession of two black marks.

If the time on the timer A is not found to correspond to a succession of two black marks, the print control block determines that the beginning of the first color has yet to be reached and returns to step ST82. If in step ST87 the time on the timer A is found to correspond to a succession of two black marks, then the print control block reaches step ST88 and terminates the process of waiting for two black marks to be detected in succession.

As described above, the ink ribbon 121 used by the printer 100 shown in FIG. 1 is composed of the base film 201 with ink coat regions of different colors. On the base film 201 of the ink ribbon 121, the starting position of each of the ink coat regions in yellow (Y), magenta (M) and cyan (C) is identified for detection purposes by the sensor mark SM formed using colors selected from the colors of the ink coat regions. That means there is no need to apply black ink to the base film 201 for ink coat identification as in the traditional production of the ink ribbon 121. Such reductions in the number of production steps contribute to manufacturing the ink ribbon 121 at lower costs than before.

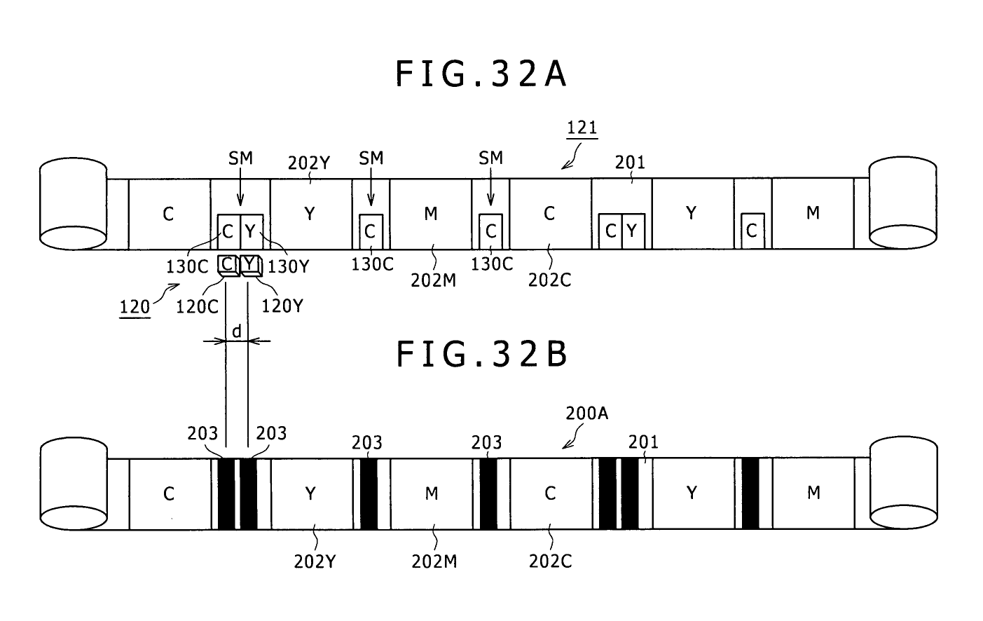

On the ink ribbon 121 used by the printer 100 shown in FIG. 1, the lengthwise array of a given ink coat region and of the ensuing ink coat constituting a sensor mark SM can become the same as the lengthwise array of the first and the second color ink coats constituting a sensor mark SM identifying the first color of one set of ink coat regions. In such a case, the distance between a given ink coat region on the one hand and the ensuing ink coat constituting a sensor mark SM on the other hand is made greater than the distance between the first and the second color ink coats making up another sensor mark SM for detecting the beginning of the first of one set of color ink coat regions for single-image formation. This arrangement makes it possible to prevent unfailingly the erroneous detection of the starting position of the first color ink coat region.

Where the ink ribbon 121 of FIG. 32A is used by the printer 100 shown in FIG. 1, the mark sensor 120 may be formed by a cyan (C) sensor 120C and a yellow (Y) sensor 120Y arrayed in the lengthwise direction of the base film 201 as illustrated.

In this case, the distance “d” between the sensor 120C and the sensor 120Y may be set substantially equal to the distance between two black marks 203 for detecting the beginning of a first color on the ordinary ink ribbon 200A. If that is the case, the printer 100 equipped with the above-described mark sensor 120 can use the ordinary ink ribbon 200A as well.

In the case above, the first color (i.e., yellow) may be detected, on the ink ribbon 121 of FIG. 32A as well as on the ink ribbon 200A of FIG. 32B, by both the cyan sensor 120C and the yellow sensor 120Y going Low (“L”) in detection output. The second and the third colors (i.e., magenta and cyan) may each be detected, on the ink ribbon 121 of FIG. 32A as well as on the ink ribbon 200A of FIG. 32B, by both the cyan sensor 120C in detection output.

Whereas the printer 100 in FIG. 1 is shown illustratively to print images on the print sheet 124, this is not limitative of the present invention. The invention also applies advantageously to printers designed to print characters and graphics.

In brief, this invention applies to the ink ribbon for use by thermal transfer printers for printing images, characters, graphics, etc., on print sheets.

The present application contains subject matter related to that disclosed in Japanese Priority Patent Application JP 2008-088758 filed in the Japan Patent Office on Mar. 28, 2008, the entire content of which is hereby incorporated by reference.

It should be understood by those skilled in the art that various modifications, combinations, sub-combinations and alterations may occur depending on design requirements and other factor in so far as they are within the scope of the appended claims or the equivalents thereof.

What is claimed is:

1. An ink ribbon comprising:
a base film having lengthwise shape;
a plurality of ink coat regions formed on said base film side by side at intervals of a predetermined distance in the lengthwise direction of said base film; and
sensor marks formed on said base film between said ink coat regions to be used to detect the beginning of each of said ink coat regions, wherein
said plurality of ink coat regions are constituted by repetition of the regions in a predetermined number of different colors, and
said sensor marks are constituted of ink coats of colors selected from said predetermined number of different colors.

2. The ink ribbon according to claim 1, wherein said sensor marks positioned at the beginning of said ink ribbon regions in said predetermined number of different colors are constituted of a first color ink coat and a second color ink coat.

3. The ink ribbon according to claim 2, wherein said first color ink coat and said second color ink coat are arrayed in the lengthwise direction of said base film.

4. The ink ribbon according to claim 3, wherein
when a first distance is the distance in the lengthwise direction of said base film between said first color ink coat and said second color ink coat and a second distance is the distance in the lengthwise direction of said base film between a region of said first color ink coat formed on said base film on the one hand and said sensor mark constituted of said second color ink coat adjacent to said region of said first color ink coat on the other hand; and
said first and said second distances are arranged in such a manner that said second distance is longer than said first distance.

5. The ink ribbon according to claim 2, wherein said first color ink coat and said second color ink coat are arrayed in the crosswise direction of said base film.

6. The ink ribbon according to claim 1, wherein said predetermined number of colors are yellow, magenta, and cyan.

7. The ink ribbon according to claim 1, wherein said predetermined number of colors are yellow, magenta, cyan, and laminate.

8. A printer comprising:
an ink ribbon mounting section configured to be a section on which to mount an ink ribbon including
a base film having lengthwise shape,
a plurality of ink coat regions formed on said base film side by side at intervals of a predetermined distance in the lengthwise direction of said base film, and
sensor marks formed on said base film between said ink coat regions to be used to detect the beginning of each of said ink coat regions, wherein
said plurality of ink coat regions are constituted by repetition of the regions in a predetermined number of different colors, and
said sensor marks are constituted of ink coats of colors selected from said predetermined number of different colors;
an ink ribbon feed section configured to feed said ink ribbon mounted on said ink ribbon mounting section in the lengthwise direction of said base film;
a sensor mark detection section configured to detect said sensor marks on said ink ribbon fed by said ink ribbon feed section;
a print head configured to be supplied with print data; and
a print control section configured to control said ink ribbon feed section and said print head in operation based on detection outputs of said sensor mark detection section.
